(19) United States
(12) Patent Application Publication
(10) Pub. No.: US 2020/0126071 A1
(43) Pub. Date: Apr. 23, 2020

(54) System and Method of Synchronized Exchange for Securing Crypto Orders

(71) Applicant: Thomas Perry, Royal Oak, MI (US)

(72) Inventor: Thomas Perry, Royal Oak, MI (US)

(21) Appl. No.: 16/656,440

(22) Filed: Oct. 17, 2019

Related U.S. Application Data
(60) Provisional application No. 62/746,763, filed on Oct. 17, 2018.

(51) Int. Cl. G06Q 20/38; H04L 29/06; H04L 9/32

(52) U.S. Cl. CPC G06Q 20/382; H04L 63/18; H04L 2209/56; H04L 63/0272; H04L 2209/38; H04L 9/3234

(57) ABSTRACT

Systems, devices, products, apparatus, and/or methods for protecting crypt orders provide a crypt order synchronized exchange by receiving a crypt order in a global exchange via a first private network of a crypto safety system, determining, in the global exchange and based on crypt order information, a local crypt order including one or more private crypto criteria to be completed as a private crypt order, wherein the crypt order information, or a safety token based on the crypt order information, identifies at least one local crypto exchange, generating a second private network for communicating a local crypt order and monitoring for a global crypt order; and completing an exchange of the local crypt order by satisfying the one or more private crypto criteria in the local crypto exchange, when the local crypt order is approved in the local crypto exchange based on the crypt order information via a second private network.

### CROSS REFERENCE TO RELATED APPLICATION

This application claims the benefit of U.S. Provisional Application No. 62/746,763 filed Oct. 17, 2018, the entire disclosure of which is hereby incorporated by reference in its entirety.

### COPYRIGHT NOTIFICATION

A portion of the disclosure of this patent document contains material which is subject to copyright protection. The copyright owner has no objection to the facsimile reproduction by anyone of the patent document or the patent disclosure, as it appears in the Patent and Trademark Office patent file or records, but otherwise reserves all copyright rights whatsoever.

### BACKGROUND

### Field of the Invention

The present invention relates generally to crypt order messaging and synchronized crypt order exchanges for securing a crypt order, and, in particular, for increasing the security of private and protective systems, devices, terminals, apparatuses, and methods of generating, transmitting, communicating, fulfilling, and determining crypto trades and crypt orders in a physically restricted environment containing software restrictions to control and eliminate threats and risks from external sources.

### Description of Related Art

The rapid growth of bitcoin and other cryptocurrency assets has created new vulnerabilities in the international financial system as a number of weaknesses are exploited. To manage cryptocurrencies, centralized and decentralized cryptocurrency exchanges are used. A cryptocurrency exchange, or a digital currency exchange (“DCE”), provides customers a platform to trade cryptocurrencies or digital currencies for other assets, such as conventional fiat money or an alternative digital currency.

Cryptocurrency exchanges (e.g., centralized and decentralized exchanges, etc.) utilize web technology and cybersecurity to operate their websites and trading exchange platforms, including public DNS servers to route crypt orders over the internet. However, cybersecurity breaches and attacks on critical financial infrastructure represent a major source of risk due to the potential ability for undermining cross-border payment systems and disrupting the flow of goods and services. Billions of dollars' worth of cryptocurrency has been stolen over the past two years. The International Monetary Fund (IMF) has warned people about using crypto exchanges, acknowledging its potential risks.

As an example, web technology can involve a multitude of script libraries, code libraries, and many third-party plugins. Many scripts and script languages are commonly understood as being prone to a number of vulnerabilities, for example, Apache web servers, one of the world's most widely used web server software, has been a victim of numerous and notorious vulnerabilities. These vulnerabilities render systems prone to various forms of malicious attacks and other internet frauds leading to information theft and loss.

Another example includes scripting languages, such as Node.js, which represents a unifying web application development around a single programming language (e.g., JavaScript, Node.js, active server pages, etc.) that is known to infuse hundreds of vulnerabilities into webpages due to misconfiguration, outdated packages, or bugs. Another example of vulnerability includes source code and libraries of source code underlying these important technologies. Java vulnerabilities, for instance, are numerous and include issues in the hardware and operating system, as well as in existing libraries used to implement the application and/or runtime environment (e.g., improper construction of SQL queries leading to SQL injection vulnerabilities).

In some existing systems, vulnerability involves the use of third-party hosting solutions. For example, many large crypto exchanges use solutions to host exchanges on the infrastructure of external corporations. However, hosted exchanges that provide services via web servers and browsers use standard hypertext protocols (e.g., hypertext transfer protocol (“HTTP”), secure hypertext transfer protocol (“HTTPS”), etc.), and standard messaging calls (e.g., HTTPS based calls, POST, GET, etc.). Standard protocols are generally well known by the public and are known to be the subject of many vulnerabilities, even when using the secure version of protocols such as HTTPS, in associated devices and the web servers that serve them.

### BRIEF DESCRIPTION OF THE DRAWINGS

Provided are systems, devices, products, apparatuses, and/or methods for improving protection of crypto exchanges, improving protection of secret keys and other private information for crypto exchange, improving privacy between computer devices and components of crypto exchanges, and/or the like. According to some non-limiting embodiments or aspects, provided is a computing system for protecting crypt orders, including a crypto safety device, a global exchange, and a plurality of local crypto exchanges, the global exchange is programmed to: receive a crypt order in a global exchange via a first private network from the crypto safety device; determining, in the global exchange and based on crypt order information, a local crypt order including one or more private crypto criteria to be completed as a private crypt order, wherein the crypt order information, or a safety token based on the crypt order information, identifies at least one local crypto exchange; complete an exchange of the crypt order by sending the local crypt order to a local crypto exchange to satisfy the one or more private crypto criteria in the local crypto exchange, wherein the local crypt order received in the local crypto exchange is based on the crypt order information via a second private network; and protect a global and local crypto order including an approved order for the crypto order via the second private network to the global exchange.

In some non-limiting embodiments or aspects, the method comprises: generating the crypt order at a crypto safety device; and communicating the crypt order via a private network to prevent unauthorized access to crypt order information and the local crypto exchange, wherein communicating comprises transmitting the completed crypt order over a private network comprising a predefined unique communication and predetermined network interface.

In some non-limiting embodiments or aspects, the crypt order information includes crypt order node information identifying at least one node of a blockchain network and the at least one node is associated with a at least one of a plurality of distributed cryptocurrency nodes, a privately held node, a government node, or a limited distributed node, for maintaining a transaction record for a crypt order or a private criteria of a crypt order.

In some non-limiting embodiments or aspects, determining the global criteria further comprises: monitoring one or more unique crypt order interfaces; and blocking at least one crypt order from obtaining the first or second private network to prevent an external requester having network access.

In some non-limiting embodiments or aspects, completing an exchange of the local crypt order further comprises: protecting the local crypt order by confirming crypt order information for an authorized one or more of: a crypto safety device, one or more global exchanges, or one or more local exchanges, and blocking a crypt order or one or more associated messages from an external device that cannot be confirmed.

In some non-limiting embodiments or aspects, at least one of the crypto safety device, the global exchange, or the local crypto exchange sends a synchronized crypt order or the safety token comprising crypt order information associating the crypt order with a crypt order criteria or related crypt order, the safety token based on the crypt order information is transformed to identify at least one of a local crypto exchange, an originating crypto safety device, an identifier associated with a private key of the crypt order, or one or more user accounts, and wherein at least one of a plurality of global exchanges confirms a crypt order based on the safety token.

In some non-limiting embodiments or aspects, the method further comprises initiating the crypt order by selecting the global exchange in a user interface, the global exchange associated with a preferred local crypto exchange server, wherein the preferred local crypto exchange server includes one or more measured characteristics associated with a metric about a security of the preferred local crypto exchange server; sending the crypt order to the global exchange, and approving the local crypt order in one or more local crypto exchanges, the local crypt order including a cryptocurrency node update protecting one or more local crypt order exchanges, a portion of information for the one or more private crypto criteria, one or more crypt orders, or one or more private keys, associated with approving the crypt order.

In some non-limiting embodiments or aspects, local crypto information or a local crypto token including one or more tokenized fields from the crypt order information provides private crypto information for determining a crypto order domain associated with a private network.

In some non-limiting embodiments or aspects, the global exchange generates one or more private networks for connecting a global domain of the global exchange with one or more local domains of one or more respective local exchanges.

In some non-limiting embodiments or aspects, the method further comprises updating global trade information or local trade information related to a crypt order as crypt order criteria are completed.

In some non-limiting embodiments or aspects, updating global trade information or local trade information related to a crypt order further comprises in response to determining the one or more private crypto criteria to be completed as a private crypt order of the crypt order require secret information, performing at least one of determining a target local communication address of one or more local crypto exchange servers based on the crypt order information, monitoring the target local communication address in the local crypto exchange server for local crypto orders, generating a crypt order or crypt order token for protecting communication between the local crypto exchange server or the global exchange, and queuing the crypt order for approval, by determining the crypt order is satisfied in the local crypto exchange server and the global exchange.

According to some non-limiting embodiments or aspects, a computing system includes a crypto safety device, at least one global exchange, and one or more of local crypto exchanges, wherein the global exchange is programmed or configured to receive a crypt order in a global exchange via a first private network from the crypto safety device; determine, in the global exchange and based on crypt order information, a local crypt order including one or more private crypto criteria to be completed as a private crypt order, wherein the crypt order information, or a safety token based on the crypt order information, identifies at least one local crypto exchange; complete an exchange of the crypt order by sending the local crypt order to a local crypto exchange to satisfy the one or more private crypto criteria in the local crypto exchange, wherein the local crypt order received in the local crypto exchange is based on the crypt order information via a second private network; and protect a global and local crypto order including an approved order for the crypto order via the second private network to the global exchange.

In some non-limiting embodiments or aspects, the crypto safety device is further configured to: generate the crypt order at a crypto safety device; and communicate the crypt order via a private network to prevent unauthorized access to crypt order information and the local crypto exchange, wherein communicating comprises transmitting the completed crypt order over a private network comprising a predefined unique communication and predetermined network interface.

In some non-limiting embodiments or aspects, the crypt order information includes crypt order node information identifying at least one node of a blockchain network and the at least one node is associated with a at least one of a plurality of distributed cryptocurrency nodes, a privately held node, a government node, or a limited distributed node, for maintaining a transaction record for a crypt order or a private criteria of a crypt order.

In some non-limiting embodiments or aspects, the global exchange is further configured to: monitor and generate one or more unique crypt order interfaces; and block at least one crypt order from obtaining the first or second private network to prevent an external requester having network access.

In some non-limiting embodiments or aspects, the global exchange is further configured to: protect the local crypt order by confirming crypt order information for an authorized one or more of: a crypto safety device, one or more global exchanges, or one or more local exchanges, and block a crypt order or one or more associated messages from an external device that cannot be confirmed.

In some non-limiting embodiments or aspects, at least one of the crypto safety device, the global exchange, or the local crypto exchange sends a synchronized crypt order or the safety token comprising crypt order information associating the crypt order with a crypt order criteria or related crypt order, the token based on the crypt order information is transformed to identify at least one of a local crypto exchange, an originating crypto safety device, an identifier associated with a private key of the crypt order, or one or more user accounts, and wherein at least one of a plurality of global exchanges confirms a crypt order based on the safety token.

In some non-limiting embodiments or aspects, the crypto safety device is configured to: initiate the crypt order by selecting the global exchange in a user interface, the global exchange associated with a preferred local crypto exchange server, wherein the preferred local crypto exchange server includes one or more measured characteristics associated with a metric about a security of the preferred local crypto exchange server, send the crypt order to the global exchange, and approve the local crypt order in one or more local crypto exchanges, the local crypt order including a cryptocurrency node update protecting one or more private crypt order exchanges, a portion of information for the one or more private crypto criteria, one or more crypt orders, or one or more private keys, associated with approving the crypt order.

In some non-limiting embodiments or aspects, local crypto information or a local crypto token including one or more tokenized fields from the crypt order information provides private crypto information for determining a crypto order domain associated with a private network.

In some non-limiting embodiments or aspects, the global exchange generates one or more private networks for connecting a global domain of the global exchange with one or more local domains of one or more respective local exchanges.

In some non-limiting embodiments or aspects, the method further comprising updating global trade information or local trade information related to a crypt order as crypt order criteria are completed.

In some non-limiting embodiments or aspects, updating global trade information or local trade information related to a crypt order, further comprises in response to determining the one or more private crypto criteria to be completed as a private crypt order of the crypt order require secret information, performing at least one of determining a target local communication address of one or more local crypto exchange servers based on the crypt order information, monitoring the target local communication address in the local crypto exchange server for local crypto orders, generating a crypt order or crypt order token for protecting communication between the local crypto exchange server or the global exchange, and queuing the crypt order for approval, by determining the crypt order is satisfied in the local crypto exchange server and the global exchange.

According to some non-limiting embodiments or aspects, provided is a computer program product including at least one non-transitory computer-readable medium including one or more instructions that, when executed by at least one processor, cause the at least one processor to receive a crypt order in a global exchange via a first private network of a crypto safety system; determine, in the global exchange and based on crypt order information, a local crypt order including one or more private crypto criteria to be completed as a private crypt order, wherein the crypt order information, or a safety token based on the crypt order information, identifies at least one local crypto exchange; generate a second private network for communicating a local crypt order and monitoring for a global crypt order; and complete an exchange of the local crypt order by satisfying the one or more private crypto criteria in the local crypto exchange, wherein the local crypt order is approved in the local crypto exchange based on the crypt order information via a second private network.

Further non-limiting embodiments or aspects are set forth in the following numbered clauses:

Clause 1: a method, comprising: receiving a crypt order in a global exchange via a first private network of a crypto safety system; determining, in the global exchange and based on crypt order information, a local crypt order including one or more private crypto criteria to be completed as a private crypt order, wherein the crypt order information, or a safety token based on the crypt order information, identifies at least one local crypto exchange; generating a second private network for communicating a local crypt order and monitoring for a global crypt order; and completing an exchange of the local crypt order by satisfying the one or more private crypto criteria in the local crypto exchange, wherein the local crypt order is approved in the local crypto exchange based on the crypt order information via a second private network.

Clause 2: The method of clause 1, further comprising: generating the crypt order at a crypto safety device; and communicating the crypt order via a private network to prevent unauthorized access to crypt order information and the local crypto exchange, wherein communicating comprises transmitting the completed crypt order over a private network comprising a predefined unique communication and predetermined network interface.

Clause 3: The method of any of clauses 1 or 2, wherein the crypt order information includes crypt order node information identifying at least one node of a blockchain network and the at least one node is associated with a at least one of a plurality of distributed cryptocurrency nodes, a privately held node, a government node, or a limited distributed node, for maintaining a transaction record for a crypt order or a private criteria of a crypt order.

Clause 4: The method of any of clauses 1-3, wherein determining the global criteria, further comprising: monitoring one or more unique crypt order interfaces; and blocking at least one crypt order from obtaining the first or second private network to prevent an external requester having network access.

Clause 5: The method of any of clauses 1-4, wherein completing an exchange of the local crypt order, further comprising: protecting the local crypt order by confirming crypt order information for an authorized one or more of: a crypto safety device, one or more global exchanges, or one or more local exchanges, and blocking a crypt order or one or more associated messages from an external device that cannot be confirmed.

Clause 6: The method of any of clauses 1-5, wherein at least one of the crypto safety device, the global exchange, or the local crypto exchange sends a synchronized crypt order or the safety token comprising crypt order information associating the crypt order with a crypt order criteria or related crypt order, the safety token based on the crypt order information is transformed to identify at least one of a local crypto exchange, an originating crypto safety device, an identifier associated with a private key of the crypt order, or one or more user accounts, and wherein at least one of a plurality of global exchanges confirms a crypt order based on the safety token.

Clause 7: The method of any of clauses 1-6, further comprising initiating the crypt order by selecting the global exchange in a user interface, the global exchange associated with a preferred local crypto exchange server, wherein the preferred local crypto exchange server includes one or more measured characteristics associated with a metric about a security of the preferred local crypto exchange server; sending the crypt order to the global exchange; and approving the local crypt order in one or more local crypto exchanges, the local crypt order including a cryptocurrency node update protecting one or more local crypt order exchanges, a portion of information for the one or more private crypto criteria, one or more crypt orders, or one or more private keys, associated with approving the crypt order.

Clause 8: The method of any of clauses 1-7, wherein local crypto information or a local crypto token including one or more tokenized fields from the crypt order information provides private crypto information for determining a crypto order domain associated with a private network.

Clause 9: The method of any of clauses 1-8, wherein the global exchange generates one or more private networks for connecting a global domain of the global exchange with one or more local domains of one or more respective local exchanges.

Clause 10: The method of any of clauses 1-9, further comprising updating global trade information or local trade information related to a crypt order as crypt order criteria are completed.

Clause 11: The method of any of clauses 1-10, wherein updating global trade information or local trade information related to a crypt order, further comprising, in response to determining the one or more private crypto criteria to be completed as a private crypt order of the crypt order require secret information, performing at least one of determining a target local communication address of one or more local crypto exchange servers based on the crypt order information; monitoring the target local communication address in the local crypto exchange server for local crypto orders; generating a crypt order or crypt order token for protecting communication between the local crypto exchange server or the global exchange; and queuing the crypt order for approval, by determining the crypt order is satisfied in the local crypto exchange server and the global exchange.

Clause 12: A computing system comprising: a crypto safety device, a global exchange, and a plurality of local crypto exchanges, wherein the global exchange is programmed or configured to: receive a crypt order in a global exchange via a first private network from the crypto safety device; determine, in the global exchange and based on crypt order information, a local crypt order including one or more private crypto criteria to be completed as a private crypt order, wherein the crypt order information, or a safety token based on the crypt order information, identifies at least one local crypto exchange; complete an exchange of the crypt order by sending the local crypt order to a local crypto exchange to satisfy the one or more private crypto criteria in the local crypto exchange, wherein the local crypt order received in the local crypto exchange is based on the crypt order information via a second private network; and protect a global and local crypto order including an approved order for the crypto order via the second private network to the global exchange.

Clause 13: The computing system of clause 12, wherein the crypto safety device is further configured to: generate the crypt order at a crypto safety device; and communicate the crypt order via a private network to prevent unauthorized access to crypt order information and the local crypto exchange, wherein communicating comprises transmitting the completed crypt order over a private network comprising a predefined unique communication and predetermined network interface.

Clause 14: The computing system of clauses 12 or 13, wherein the crypt order information includes crypt order node information identifying at least one node of a blockchain network and the at least one node is associated with a at least one of a plurality of distributed cryptocurrency nodes, a privately held node, a government node, or a limited distributed node, for maintaining a transaction record for a crypt order or a private criteria of a crypt order.

Clause 15: The computing system of clauses 12-14, wherein the global exchange is further configured to: monitor and generate one or more unique crypt order interfaces; and block at least one crypt order from obtaining the first or second private network to prevent an external requester having network access.

Clause 16: The computing system of clauses 12-15, wherein the global exchange is further configured to: protect the local crypt order by confirming crypt order information for an authorized one or more of: a crypto safety device, one or more global exchanges, or one or more local exchanges, and block a crypt order or one or more associated messages from an external device that cannot be confirmed.

Clause 17: The computing system of clauses 12-16, wherein at least one of the crypto safety device, the global exchange, or the local crypto exchange sends a synchronized crypt order or the safety token comprising crypt order information associating the crypt order with a crypt order criteria or related crypt order, the token based on the crypt order information is transformed to identify at least one of a local crypto exchange, an originating crypto safety device, an identifier associated with a private key of the crypt order, or one or more user accounts, and wherein at least one of a plurality of global exchanges confirms a crypt order based on the safety token.

Clause 18: The computing system of clauses 12-17, wherein the crypto safety device is configured to: initiate the crypt order by selecting the global exchange in a user interface, the global exchange associated with a preferred local crypto exchange server, wherein the preferred local crypto exchange server includes one or more measured characteristics associated with a metric about a security of the preferred local crypto exchange server; send the crypt order to the global exchange; and approve the local crypt order in one or more local crypto exchanges, the local crypt order including a cryptocurrency node update protecting one or more private crypt order exchanges, a portion of information for the one or more private crypto criteria, one or more crypt orders, or one or more private keys, associated with approving the crypt order.

Clause 19: The computing system of clauses 12-18, wherein local crypto information or a local crypto token including one or more tokenized fields from the crypt order information provides private crypto information for determining a crypto order domain associated with a private network.

Clause 20: The computing system of clauses 12-19, wherein the global exchange generates one or more private networks for connecting a global domain of the global exchange with one or more local domains of one or more respective local exchanges.

Clause 21: The computing system of clauses 12-20, further comprising updating global trade information or local trade information related to a crypt order as crypt order criteria are completed.

Clause 22: The computing system of clauses 12-21, wherein updating global trade information or local trade information related to a crypt order, further comprising: in response to determining the one or more private crypto criteria to be completed as a private crypt order of the crypt order require secret information, performing at least one of: determining a target local communication address of one or more local crypto exchange servers based on the crypt order information; monitoring the target local communication address in the local crypto exchange server for local crypto orders; generating a crypt order or crypt order token for protecting communication between the local crypto exchange server or the global exchange; and queuing the crypt order for approval, by determining the crypt order is satisfied in the local crypto exchange server and the global exchange.

### BRIEF DESCRIPTION OF THE DRAWINGS

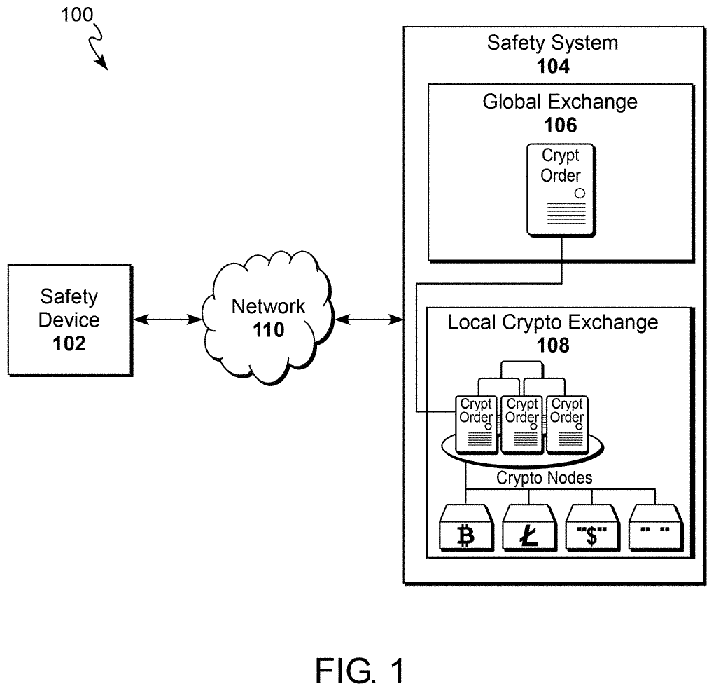

FIG. 1 illustrates a diagram of a non-limiting embodiment or aspect of a synchronized exchange system for securing a crypt order;

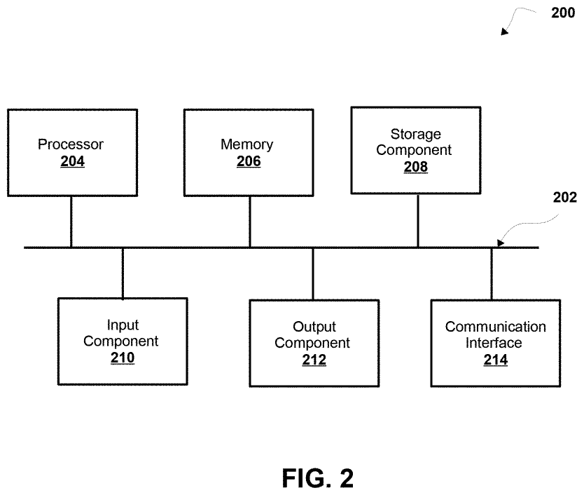

FIG. 2 illustrates a diagram of a non-limiting embodiment or aspect of components of one or more devices and/or one or more systems of FIG. 1;

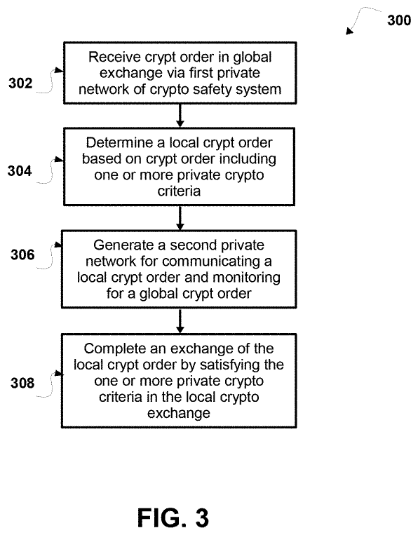

FIG. 3 illustrates a flowchart of a non-limiting embodiment or aspect of a synchronized exchange for protecting a crypt order;

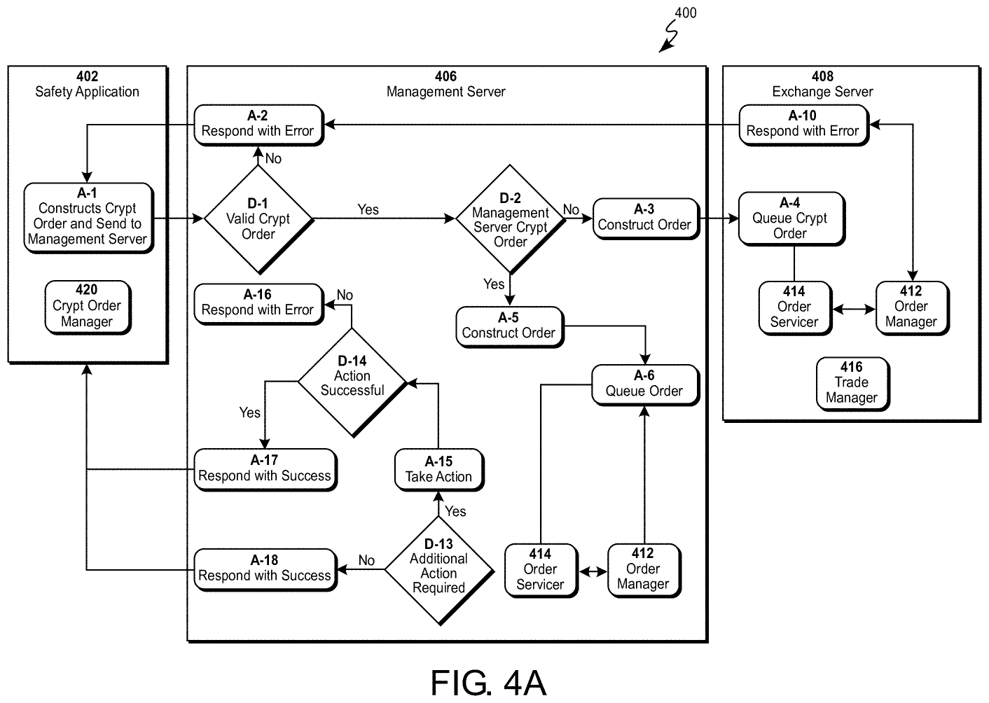

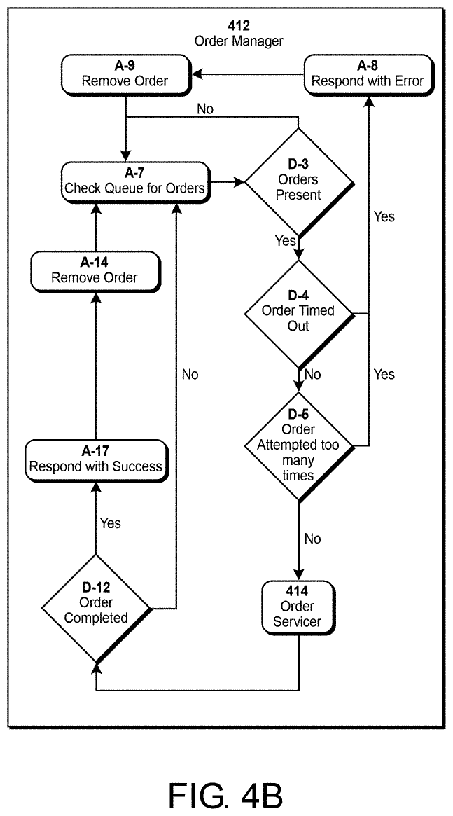

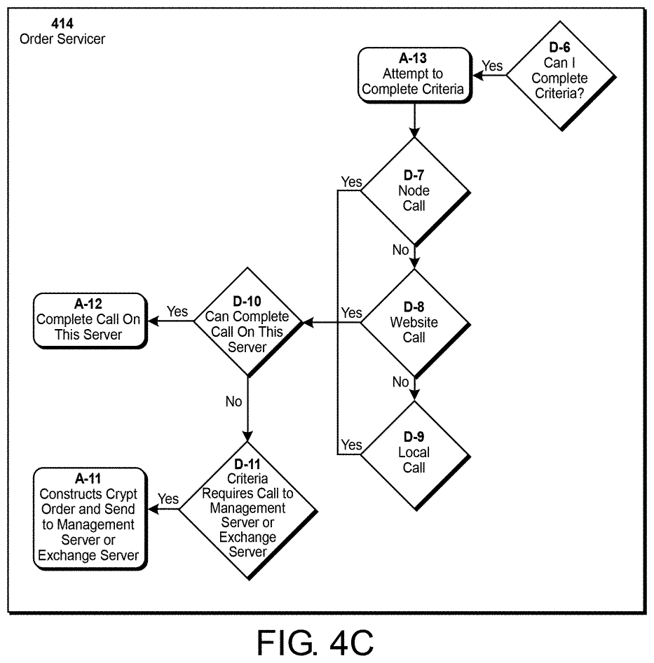

FIG. 4A illustrates a diagram of a non-limiting embodiment or aspect of a crypt order synchronized messaging environment in which systems and/or methods, described herein, for initiating a secure crypt order can be implemented;

FIG. 4B illustrates a diagram of a non-limiting embodiment or aspect of an order manager software component of a crypt order synchronized messaging environment;

FIG. 4C illustrates a diagram of a non-limiting embodiment or aspect of an order servicer software component of a crypt order synchronized messaging environment;

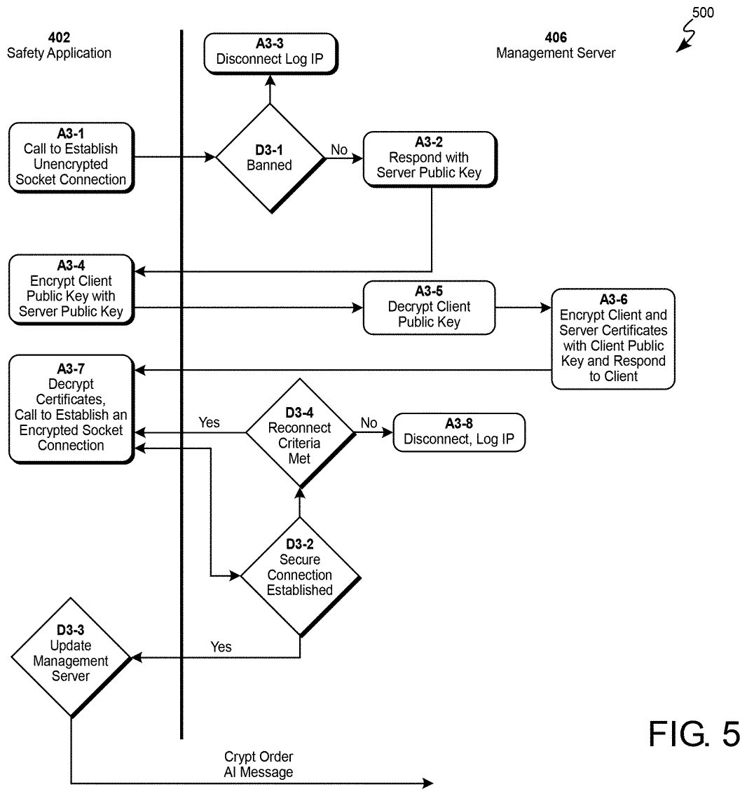

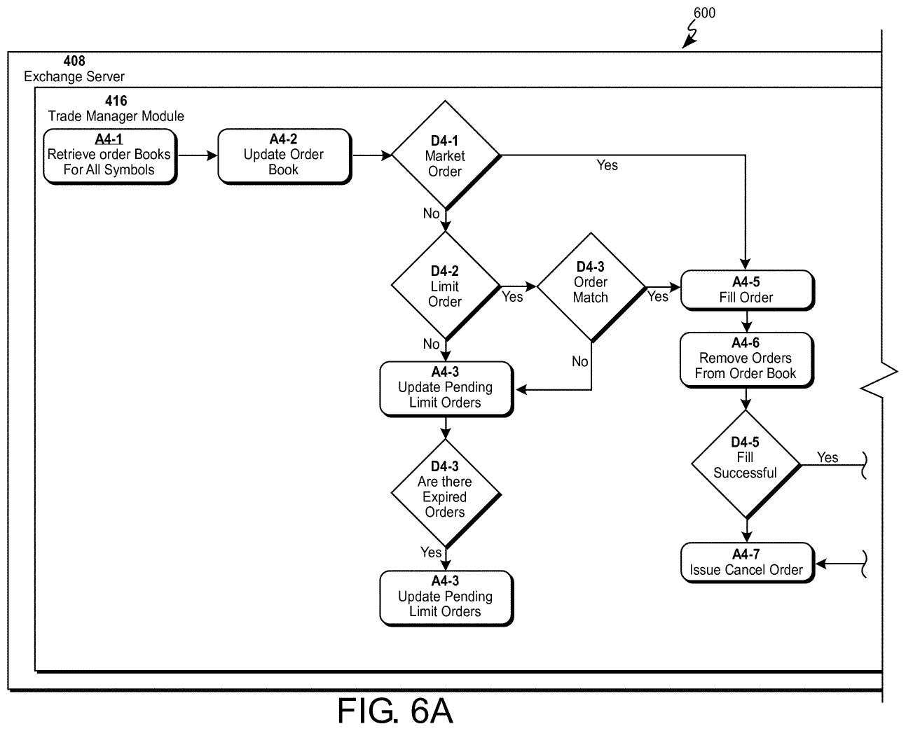

FIG. 5 illustrates a diagram of a non-limiting embodiment or aspect for connecting a safety device and global exchange in a synchronized exchange;

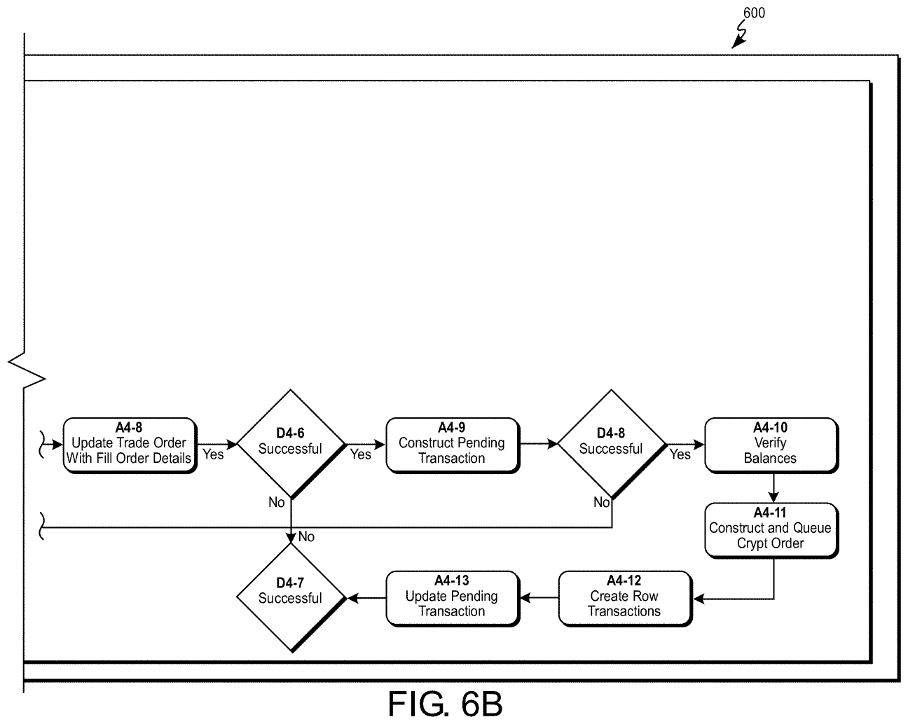

FIGS. 6A and 6B illustrate a diagram of a non-limiting embodiment of a trade manager software component for approving a crypt order in a crypt order synchronized messaging environment;

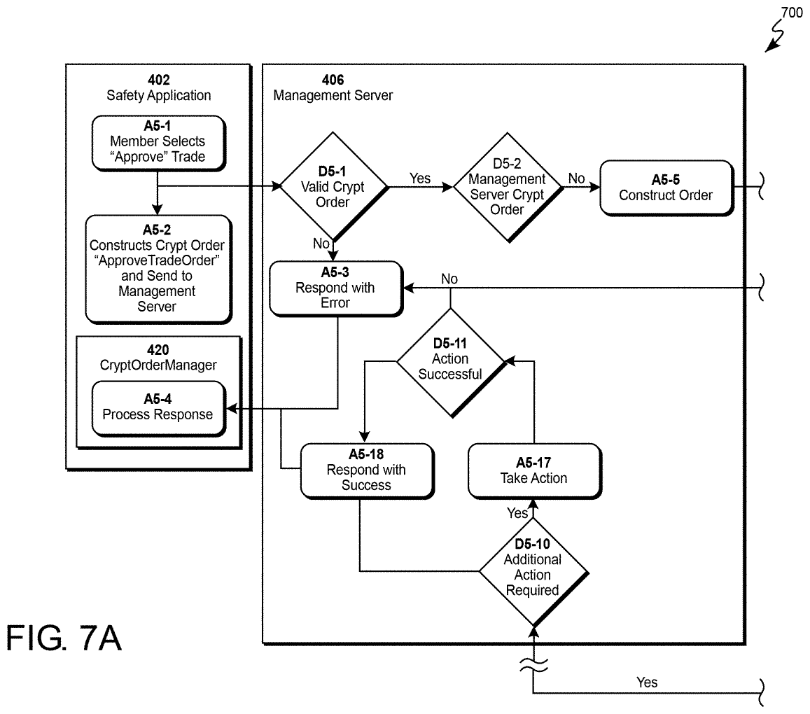

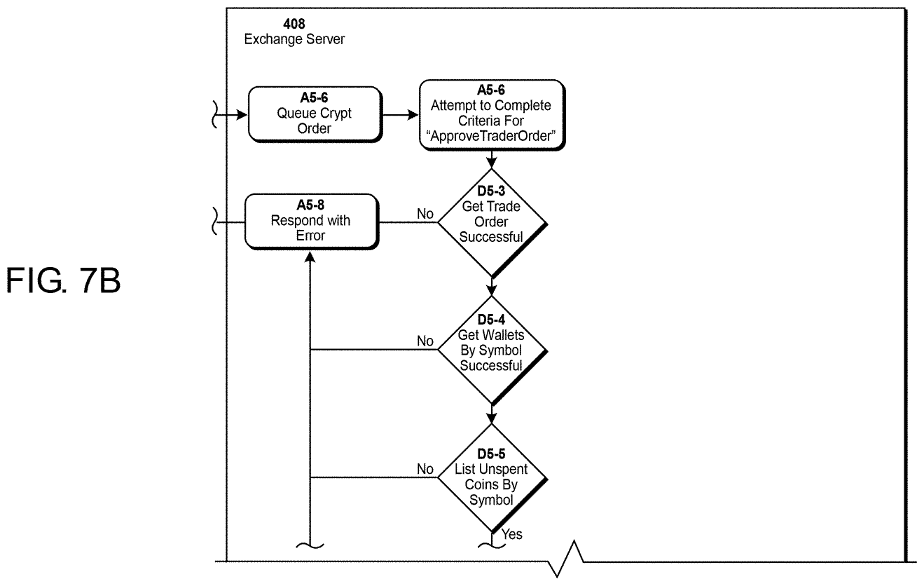

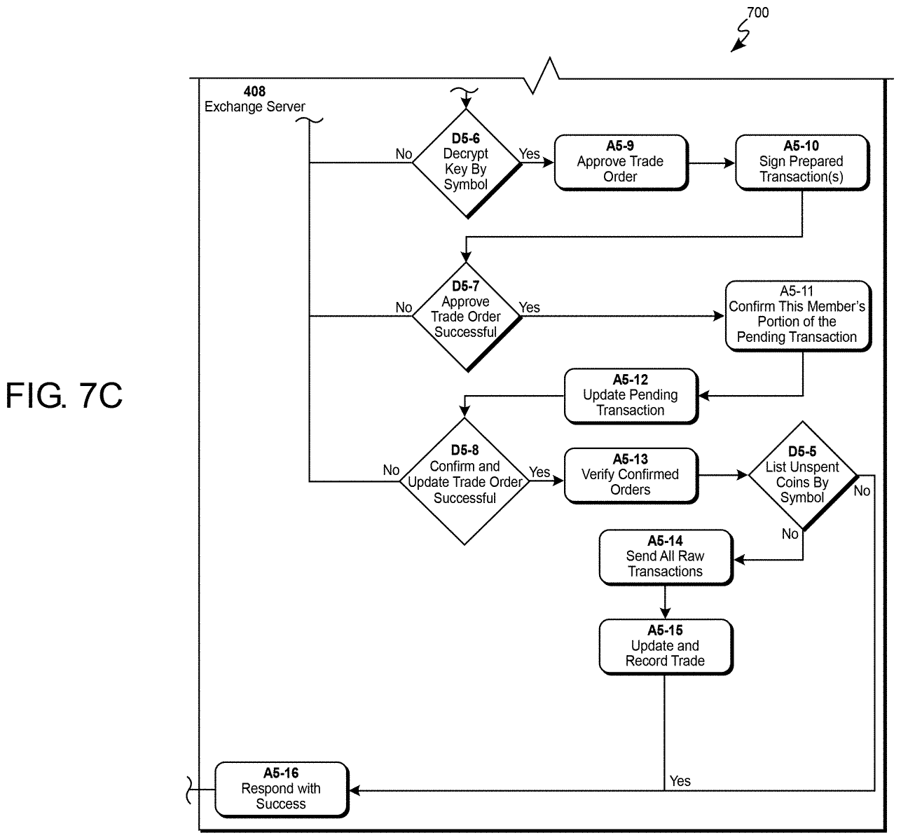

FIGS. 7A, 7B and 7C illustrate a diagram of a non-limiting embodiment or aspect for approving a local crypto exchange server and a global exchange server in a crypt order synchronized messaging environment;

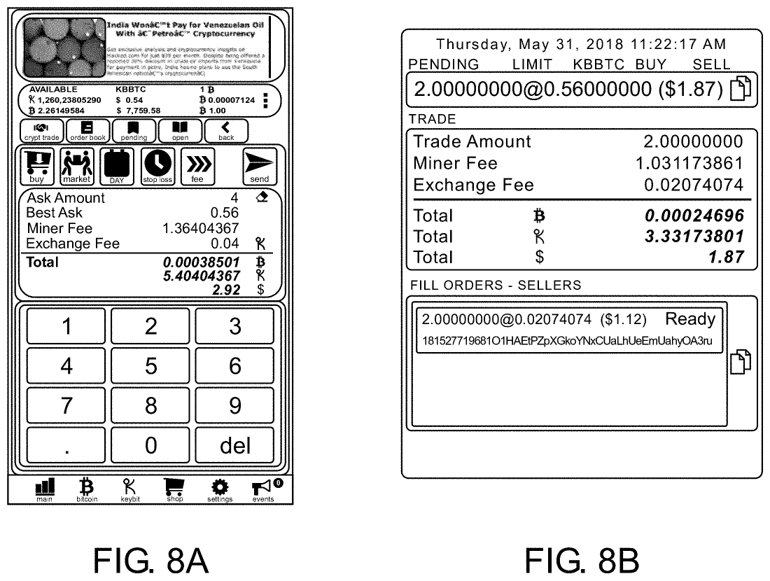

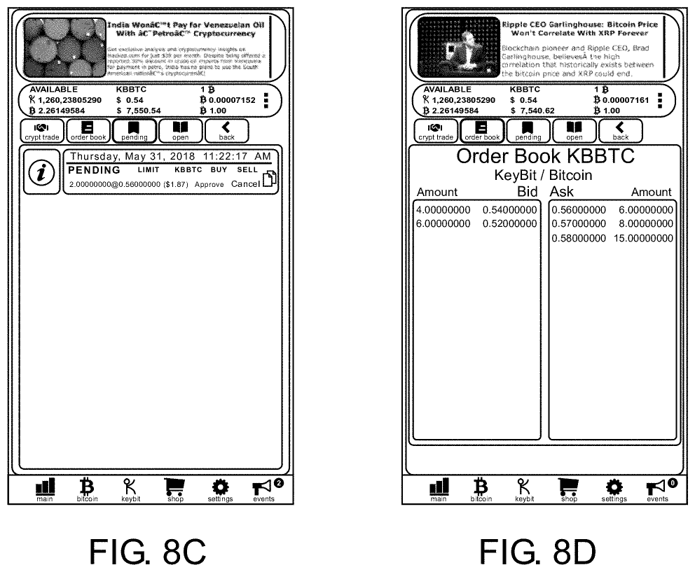

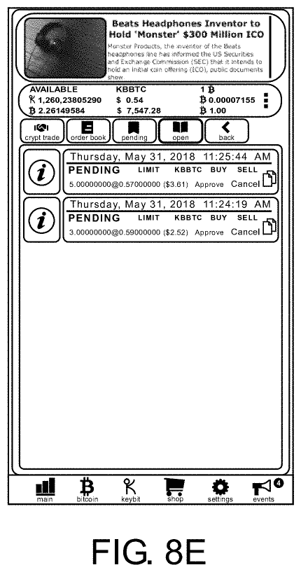

FIGS. 8A-8E illustrate an implementation of a non-limiting embodiment or aspect for a crypt order trade approval manager; and

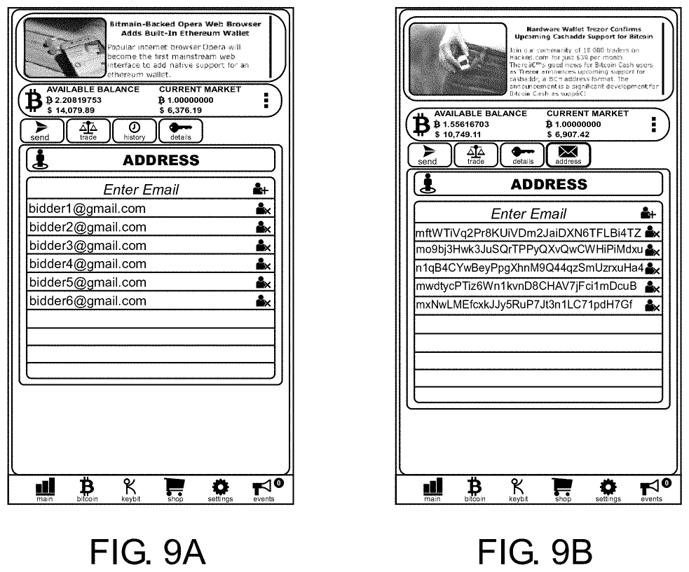

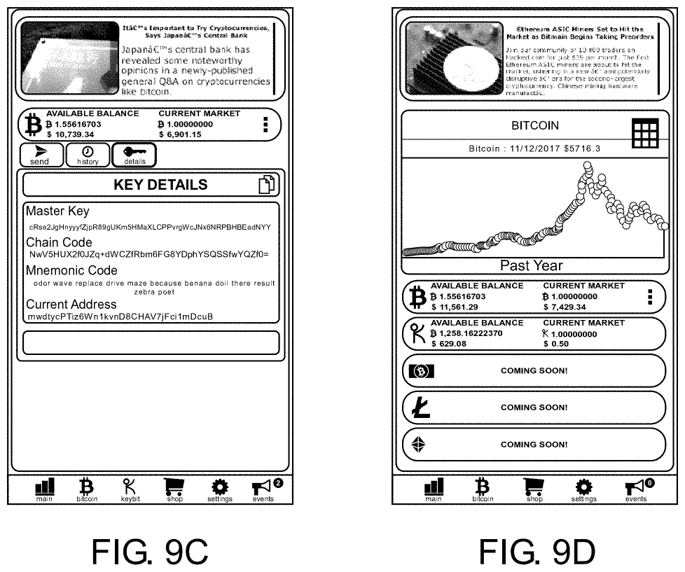

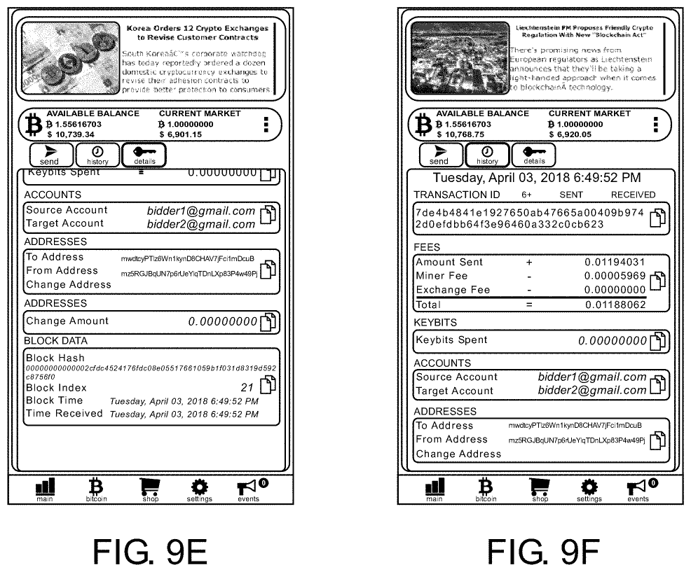

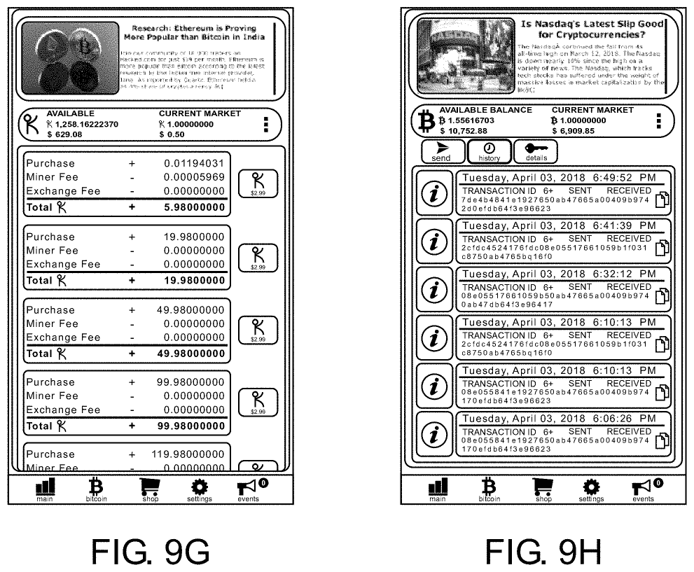

FIGS. 9A-9H illustrate an implementation of a non-limiting embodiment or aspect for a crypt order trade approval.

### DETAILED DESCRIPTION

It is to be understood that the present disclosure may assume various alternative variations and step sequences, except where expressly specified to the contrary. It is also to be understood that the specific devices and processes illustrated in the attached drawings, and described in the following specification, are simply exemplary and non-limiting embodiments or aspects. Hence, specific dimensions and other physical characteristics related to the embodiments or aspects disclosed herein are not to be considered as limiting.

For purposes of the description hereinafter, the terms “end,” “upper,” “lower,” “right,” “left,” “vertical,” “horizontal,” “top,” “bottom,” “lateral,” “longitudinal,” and derivatives thereof shall relate to embodiments or aspects as they are oriented in the drawing figures. However, it is to be understood that embodiments or aspects may assume various alternative variations and step sequences, except where expressly specified to the contrary. It is also to be understood that the specific devices and processes illustrated in the attached drawings, and described in the following specification, are simply non-limiting exemplary embodiments or aspects. Hence, specific dimensions and other physical characteristics related to the embodiments or aspects disclosed herein are not to be considered as limiting unless otherwise indicated.

No aspect, component, element, structure, act, step, function, instruction, and/or the like used herein should be construed as critical or essential unless explicitly described as such. Also, as used herein, the articles “a” and “an” are intended to include one or more items, and may be used interchangeably with “one or more” and “at least one.” Furthermore, as used herein, the term “set” is intended to include one or more items (e.g., related items, unrelated items, a combination of related and unrelated items, etc.) and may be used interchangeably with “one or more” or “at least one.” Where only one item is intended, the term “one” or similar language is used. Also, as used herein, the terms “has,” “have,” “having,” or the like, are intended to be open-ended terms. Further, the phrase “based on” is intended to mean “based at least partially on” unless explicitly stated otherwise.

As used herein, the terms “communication” and “communicate” may refer to the reception, receipt, transmission, transfer, provision, and/or the like of information (e.g., data, signals, messages, instructions, commands, and/or the like). For one unit (e.g., a device, a system, a component of a device or system, combinations thereof, and/or the like) to be in communication with another unit means that the one unit is able to directly or indirectly receive information from and/or transmit information to the other unit. This may refer to a direct or indirect connection that is wired and/or wireless in nature. Additionally, two units may be in communication with each other even though the information transmitted may be modified, processed, relayed, and/or routed between the first and second unit. For example, a first unit may be in communication with a second unit even though the first unit passively receives information and does not actively transmit information to the second unit. As another example, a first unit may be in communication with a second unit if at least one intermediary unit (e.g., a third unit located between the first unit and the second unit) processes information received from the first unit and communicates the processed information to the second unit. In some non-limiting embodiments or aspects, a message may refer to a network packet (e.g., a data packet and/or the like) that includes data. It will be appreciated that numerous other arrangements are possible.

As used herein, the term “computing device” may refer to one or more electronic devices that are configured to directly or indirectly communicate with or over one or more networks. A computing device may be a mobile or portable computing device, a desktop computer, a server, and/or the like. Furthermore, the term “computer” may refer to any computing device that includes the necessary components to receive, process, and output data, and normally includes a display, a processor, a memory, an input device, and a network interface. A “computing system” may include one or more computing devices or computers. An “application” or “application program interface” (API) refers to computer code or other data sorted on a computer-readable medium that may be executed by a processor to facilitate the interaction between software components, such as a client-side front-end and/or server-side back-end for receiving data from the client. An “interface” refers to a generated display, such as one or more graphical user interfaces (GUIs) with which a user may interact, either directly or indirectly (e.g., through a keyboard, mouse, touchscreen, etc.). Further, multiple computers, e.g., servers, or other computerized devices, such as a crypto safety system, directly or indirectly communicating in the network environment may constitute a “system” or a “computing system”.

It will be apparent that the systems and/or methods described herein can be implemented in different forms of hardware, software, or a combination of hardware and software. The actual specialized control hardware or software code used to implement these systems and/or methods is not limiting of the implementations. Thus, the operation and behavior of the systems and/or methods are described herein without reference to specific software code, it being understood that software and hardware can be designed to implement the systems and/or methods based on the description herein.

Some non-limiting embodiments or aspects are described herein in connection with thresholds. As used herein, satisfying a threshold may refer to a value being greater than the threshold, more than the threshold, higher than the threshold, greater than or equal to the threshold, less than the threshold, fewer than the threshold, lower than the threshold, less than or equal to the threshold, equal to the threshold, etc.

Some non-limiting embodiments or aspects are described herein in connection with nodes. As used herein, the term “node” may refer to one or more devices connecting to a blockchain network, such as a computer, mobile device, or point of sale terminal, further configured to communicate via an internet connection, and as such having an IP address. The role of a node is to support the network by maintaining a copy of a blockchain and, in some non-limiting embodiments or aspects, to process transactions (e.g., store and validate transactions, mining, forging, etc.). A single node can obtain an entire copy of a blockchain for a particular cryptocurrency such that all the order records are intact.

In some non-limiting embodiments or aspects, a node is an endpoint. For example, a node downloads a complete copy of a blockchain and verifies any new transactions based on a consensus protocol utilized by a particular cryptocurrency or universal token while the device is connected to the network. A node on the network can confirm and validate transactions, putting them into blocks. Nodes may come to their own conclusion on whether a transaction is valid and should be added to a block with other transactions, irrespective of how other nodes behave.

Some non-limiting embodiments or aspects are described herein in connection with cryptocurrency wallets. As used herein, the term “crypto wallets” may refer to storage tools used by cryptocurrency exchanges to store crypto holdings. Crypto wallets may include hot wallets that are connected to the internet or cold wallets that are stored offline. However, using a hot wallet increases the number of risks for theft and attacks. For example, hackers, social engineers, and unscrupulous employees use hot wallets to gain access to stored credentials (e.g., a private key needed to transfer funds on a blockchain).

Some non-limiting embodiments or aspects are described herein in connection with a private network. As used herein, the term “private network” may refer to a connection within a specified network having restrictions that are established to promote a secured environment. A private network is one which either does not connect to the public internet (e.g., a network that anyone can freely connect to with little or no restriction, etc.), or is connected to a public network such as the internet indirectly by using NAT (Network Address Translation) so that its addresses do not appear on the public network. A private network can be configured in such a way that devices outside the network cannot access it. For example, a private network can be configured so that only a selected set of devices may access this type of network depending on the settings encoded in the network routers and access points and can also be provided by physical proximity, or by entry into a network that is not published to external users, allowing connections to other computers that are on the same physical network.

Existing systems include problematic cryptocurrency exchanges. Certain exchanges clearly cannot be trusted to safeguard cryptocurrency assets. In existing systems, no compliance or custody for crypto orders is required. Until there is an improved layer of security, it will be difficult for this industry to grow in the ways many advocates would like to see. If an attacker manages to bypass firewall rules and IT infrastructure, the management server will still analyze the data it receives to determine if it is a legitimate call.

In this way, a new method for managing sensitive data over the internet starting with an analysis of the vulnerabilities of web technology solves such problems. The safety system provides a master-to-master management system that leverages unique custom messaging, back-end, front-end, and client infrastructure. The safety system provides and adheres to presently regulated banks and credit unions, allows full control of the sensitive data for the users, and is built with “best practices” IT infrastructure in mind. The safety system provides local exchanges (e.g., one or more internal computing devices) that are autonomous, but work together with little to no coordination or human involvement.

Some non-limiting embodiments or aspects of private networks that are connected to a public network such as the Internet comprise a virtual private network (VPN) programmed to provide safety and security, and in some examples, have encrypted connections over a less secure network such as the public Internet. A VPN works by using the shared public infrastructure while maintaining privacy through security procedures and tunneling protocols. In a further example, The WebSocket protocol defines a ws:// and wss:// prefix to indicate a WebSocket and a WebSocket Secure connection, respectively. This sets up a tunnel which provides low-level end-to-end transmission control protocol (TCP) communication through the HTTP proxy between the WebSocket Secure client and the WebSocket server.

In some non-limiting embodiments or aspects, Crypt Artificial Intelligence Custom Messaging (CAICM) is a custom messaging solution which is fundamentally different from HTTP(S). It is the container used to facilitate transmission of data between the client and server and provides decision making capability within the safety system. The management server will determine if the data being sent matches the CAICM format otherwise it is ignored and logged. CAICM does not operate in a web based environment. For example, as used herein, the term “web based environment” may refer to a system which requires three components: a browser application or an application which can transmit HTTP(S), an HTTP(S) message, and a web server to receive the HTTP(S) message.

To send an HTTP(S) message to a web server of a web based environment, a web address is supplied or entered into a browser address bar (ubiquitously known as “www.”). The browser then builds the HTTP(S) message based on a known format and transmits that message to a designated web server by name. This is the most common way to communicate over the web today and is utilized in virtually every environment from Windows-based applications to iOS-based applications, and further in development environments when communicating between applications on the same system.

An application that can transmit CAICM, includes a CAICM message (e.g., a crypt order, etc.), and a global exchange (e.g., one or more management servers that can understand and receive CAICM messages, etc.). For example, to send a CAICM message to a management server, the application automatically builds the CAICM message (using no input from the user) based on a format that is not commonly known and transmits the message to a management server via an IP address.

In some non-limiting embodiments or aspects, the CAICM message is interrogated by a global exchange to validate the format and can perform actions within the safety system that may require decision making by the system. Decisions create new CAICM messages and cascade waterfall management (e.g., data flow, etc.) to other exchange servers within the network to retrieve or collect the necessary data and then resume to the originating caller.

Communication between clients and servers using CAICM has been optimized to increase efficiency by reducing the amount of data required. For example, in some cases a crypt order includes only 3-5 bytes of data. As the management server is responsible for broadcasting non-sensitive data, such as the news of the day, to authorized clients which reduces the number of requests, the local crypto exchange can remain protected from extraneous messages (e.g., news messages and other global criteria) while focused on managing crypto nodes.

In some non-limiting embodiments or aspects, the safety system is direct socket based. For example, after generating a direct socket, connections are maintained to be open and monitored, while further eliminating significant memory and network footprints.

In existing systems, an HTTP(S) call requires, in every call, building the socket, connecting, exchanging certificates, establishing the secured connection, sending and receiving data, and finally, breaking down the socket. Downloading the certificates may use 5,000 bytes (5 kilobytes) or more of data alone. For one hundred calls averaging 50 bytes of data retrieved, an approximate total of 505 kilobytes of data are used between the certificate data and the retrieved data.

However, in the safety system, CAICM calls and builds the private network (e.g., a socket, etc.), exchanges certificates, establishes the secure connection, and then maintains the secure socket. For example, this process costs 5,000 bytes on the first call, but then subsequent calls contain only retrieved data. In the same one hundred calls averaging 50 bytes of data, only 10 kilobytes of data are used in total, ultimately requiring approximately 99% less data than the same number of HTTP(S) calls.

In some non-limiting embodiments or aspects, CAICM has been developed to interrogate data as a security measure. For example, any data sent to the safety system that is not in the correct CAICM format is ignored and the abuse of the connection is blocked and/or banned, as well as logged for future reference. The internal exchange servers have the same capability of monitoring incoming data as the management servers, and will also only accept data that is sent in the correct CAICM format. In some non-limiting embodiments or aspects, the interrogation features may include one or more of a CAICM format, an amount of data sent (e.g., too much, too little, etc.), whitelist or black list status (e.g., an approved socket remote endpoint, a banned IP, etc.), malformed values (e.g., values that mean nothing to the safety system such as HTTP/HTTP(S) formatted messages, etc.).

In some non-limiting embodiments or aspects, certificates are managed by the Al of the exchange servers. For example, the safety system includes computing devices capable of generating, labeling, signing, and deploying certificates automatically. In this way, the safety system eliminates the need for human interaction to validate a certificate by using one or more certificates that are built in a specific way and validated through a seven-point check. In some non-limiting embodiments or aspects, certificates that are disseminated to a global exchange or local crypto exchange will be distributed automatically to other management servers and exchange servers within the safety system network by using CAICM.

In some non-limiting embodiments or aspects, computing devices of the safety system include software applications that go through a security process. For example, in some non-limiting embodiments or aspects, a three-fold security process is applied through obfuscating software applications by scrambling the code and making it unreadable, converting the software language to further disguise the data (e.g., from C# to C++, etc.), and including fake functions and code injected into the binaries which are designed to be ignored within the system, thus creating no additional impact on the processing performance or the stability of the overall system.

In some non-limiting embodiments or aspects, the safety system is a master-to-master solution. Management servers and exchange servers can be added and/or activated or removed and/or deactivated at any time. This allows for automated synchronization of transaction history for users. Synchronization occurs via CAICM automatically each time a transaction is completed. Exchange servers are not available until they are fully synchronized and older data is handled by archive exchange servers or offline servers which synchronize using the same methodology. To adhere to Payment Application Data Security Standard (PA-DSS) any sensitive data that passes through the exchange server is immediately removed from memory after use.

Management servers sit in demilitarized zones (DMZ) and provide a public access point acting as the gatekeeper for any activity to and from the safety system. The management server has its own LAN and is not able to, on its own, talk to any other servers on the LAN. An exchange server is only able to respond after it has established a connection to the management server. The firewall routing rules are specific to each system further preventing unauthorized connections or attackers from gaining information about the internal LAN, intranet, or the associated IP addresses.

In some non-limiting embodiments or aspects, a crypto safety device, global exchange, and local crypto exchange do not respond to pings or yield usable ports during port scans, and the exchange server (e.g., local crypto exchange) is additionally not listening to, or bound to, any ports.

In some non-limiting embodiments or aspects, passwords (e.g., system, database, root, etc.) utilize separate strong passwords utilizing a variety of special characters, numbers, case based characters.

In some non-limiting embodiments or aspects, a safety system provides one or more a social traps (e.g. locked cages, security cameras, etc.) to physically protect a crypto safety device, global exchange, and local crypto exchange. In addition, if anyone is successful in physically stealing a hard drive from the safety system, it will be inaccessible and unusable as data is further protected with strong encryption.

Referring now to FIG. 1, FIG. 1 is an example of a crypt order synchronized messaging environment 100 in which devices, systems, methods, and/or products described herein, may be implemented. As shown in FIG. 1, crypt order synchronized messaging environment 100 includes crypto safety device 102, network 110, and safety system 104. In some non-limiting embodiments or aspects, safety system 104 may also provide one or more protected and securely-connected exchanges, such as global exchange 106, and local crypto exchange 108. Systems and/or devices of crypt order synchronized messaging environment 100 can interconnect via wired connections, wireless connections, or a combination of wired and wireless connections.

In some non-limiting embodiments or aspects, crypto safety device 102 includes one or more devices capable of communicating information and/or data to safety system 104 (e.g., global exchange 106, local crypto exchange 108, etc.) via communication network 110 and/or receiving information and/or data from safety system 104 (e.g., global exchange 106, local crypto exchange 108, etc.) via communication network 110.

In some non-limiting embodiments or aspects, crypto safety device 102 generates and/or communicates a crypt order with one or more buy orders, or in other non-limiting embodiments or aspects, one or more sell orders. As an example, crypto safety device 102 may include a safety application for crypt order protection which communicates by using unique crypt order messages (e.g., a crypt order including a cryptocurrency, price, quantity, safety token, etc.) In some non-limiting embodiments or aspects, crypto safety device 102 builds or constructs a crypt order that includes a crypto criteria (e.g., one or more requirements to complete a crypt order). For example, an application running on crypto safety device 102 (e.g., phone client, mobile device, personal digital assistant, pad or tablet computer, desktop or laptop computer, wrist watch, etc.) adds one or more crypto criteria to the crypt order.

In some embodiments, crypto safety device 102 receives and/or communicates the crypt order by using an encrypted socket. In some non-limiting embodiments or aspects, crypto safety device 102 receives and communicates with safety system 104 based on currency in an order book (e.g., a list of active buy/sell orders that have been placed for a particular coin by the exchange). Order books show how demand and supply originates in in real-time by actively tracking and displaying how many units of a currency are available, the market price, and the potential buyers and sellers for initiating the transaction.

In some non-limiting embodiments or aspects, safety system 104 includes one or more devices capable of communicating information and/or data to crypto safety device 102 (e.g., one or more safety applications of crypto safety device 102, etc.) via communication network 110 and/or receiving information and/or data from crypto safety device 102 (e.g., a safety application of crypto safety device 102, etc.) via communication network 110. For example, safety system 104 receives and or communicates a crypt order using an encrypted socket from crypto safety device 102. In another example, safety system 104 may store a crypt order in a list of active buy/sell orders that have been placed for a particular coin by the exchange and can be accessed via a secure connection by traders to view and list buy/sell orders and determine information about a market.

In some non-limiting embodiments or aspects, safety system 104 provides additional servers to manage crypt order information without storing sensitive crypt order information locally (e.g., on disk, etc.), or in other non-limiting embodiments or aspects, storing it only in memory for the purposes of processing a crypt order. The safety system 104 may validate pending transactions, such as a trade and/or exchange transaction in the blockchain using information from a pending and/or historical transaction generated by the exchange or blockchain. For example, pending orders in their entirety, with the exception of mining fees, are generated from data created by users and the exchange. In some non-limiting embodiments or aspects, historical transactions may include a total for the amount sent (e.g., amount sent, mining fee, and exchange fee, etc.), amount of crypto spent in lieu of exchange fees (e.g., using another currency for exchange fees, etc.), an account identifier, change amount, block data, block hash, block index, block time, and/or time received.

In some non-limiting embodiments or aspects, safety system 104 includes a plurality of servers (e.g., management servers and/or exchange servers stationed around the world) to create a master-to-master solution. In some non-limiting embodiments or aspects, safety system 104 includes a plurality of management servers securely-connected to at least one exchange server, one management server securely-connected to multiple exchange servers, or a plurality of management servers connected to a plurality of exchange servers, such that a management server can communicate with at least one exchange server, or in other non-limiting embodiments or aspects, a management server can determine an exchange server to communicate with based on a request from crypto safety device 102. In other non-limiting embodiments or aspects, safety system 104 provides fault tolerance regardless of server inactivity, disconnections, or attacks to ensure a safety service will remain secure and available.

In some non-limiting embodiments or aspects, communication network 110 includes one or more wired and/or wireless networks. For example, communication network 110 includes a cellular network (e.g., a long-term evolution (LTE) network, a third generation (3G) network, a fourth generation (4G) network, a fifth generation (5G) network, a code division multiple access (CDMA) network, etc.), a public land mobile network (PLMN), a local area network (LAN), WIFI, a wide area network (WAN), a metropolitan area network (MAN), a telephone network (e.g., the public switched telephone network (PSTN)), a private network, an ad hoc network, an intranet, the Internet, a fiber optic-based network, a cloud computing network, and/or the like, and/or a combination of these or other types of networks.

In some non-limiting embodiments or aspects, the global exchange 106 and the local crypto exchange 108 both have their own order manager and order servicer. In some non-limiting embodiments or aspects, only a local call is made to a database locally with no network or cloud databases used to store crypt order information. In some non-limiting embodiments or aspects, a node call is made to a cryptocurrency node. For example, one or more cryptocurrency nodes are arranged as local nodes of local crypto exchange 108. In such an example, if the order module is on the global exchange 106, it can make external web site calls, or local calls, but global exchange 106 is restricted from making calls to cryptocurrency nodes.

In some non-limiting embodiments or aspects, when the order module is on the local crypto exchange 108, node calls can be made to cryptocurrency nodes of the local crypto exchange 108, or in other non-limiting embodiments or aspects, node calls may be made to a different local crypto exchange over a private network. The local crypto exchange 108 is prevented access to external websites and cannot make calls (e.g., communicate, initiate API access, etc.) to websites or calls to other devices on the public internet. For example, in some non-limiting embodiments or aspects, local crypto exchange 108 will have no hardware means or software means to make calls to external websites. In some non-limiting embodiments or aspects, a firewall with network-level firewall protection (e.g., SonicWall, etc.) is provided to prevent the local crypto exchange 108 from accessing (e.g., having direct communication with, etc.) the internet. For example, the management server is in a demilitarized zone (DMZ) or another isolated zone specifically designed for public access. Beyond the global exchange 106, the local crypto exchange 108 will be locked down behind a firewall and only the management server will be allowed to communicate with it, and even then the global exchange 106 listens for client based calls for connection. This prevents the local crypto exchange 108 from accepting a connection outside of its designations as it is not communicating to an external server.

In some non-limiting embodiments or aspects, the local crypto exchange 108 will make a request to the global exchange 106. As an example, local crypto exchange 108 sends a global crypt order to global exchange 106 to retrieve a news article.

In some non-limiting embodiments or aspects, a criteria for a crypt order can be one or more requirements to complete a crypt order. Safety system 104 (e.g., one or more devices, such as a phone client, one or more management servers, one or more exchange servers, etc.) injects the crypto criteria while building the crypt order then sends the crypt order to the intended recipient over an encrypted socket.

The number and arrangement of systems, devices, and networks shown in FIG. 1 are provided as an example. There can be additional systems, devices and/or networks, fewer systems, devices, and/or networks, different systems, devices, and/or networks, or differently arranged systems, devices, and/or networks than those shown in FIG. 1. Furthermore, two or more systems or devices shown in FIG. 1 can be implemented within a single system or a single device, or a single system or a single device shown in FIG. 1 can be implemented as multiple, distributed systems or devices. Additionally, or alternatively, a set of systems or a set of devices (e.g., one or more systems, one or more devices) of crypt order synchronized messaging environment 100 can perform one or more functions described as being performed by another set of systems or another set of devices of crypt order synchronized messaging environment 100.

Referring now to FIG. 2, FIG. 2 is a diagram of example components of a device 200. Device 200 can correspond to one or more devices of crypto safety device 102, one or more devices of safety system 104, and/or one or more devices of (e.g., one or more devices of a system of) safety system 104, such as, global exchange 106 and local crypto exchange 108. In some non-limiting embodiments or aspects, one or more devices of crypto safety device 102, one or more devices of global exchange 106, one or more devices of local crypto exchange 108, and/or one or more devices of (e.g., one or more devices of a system of) safety system 104 can include at least one device 200 and/or at least one component of device 200. As shown in FIG. 2, device 200 includes bus 202, processor 204, memory 206, storage component 208, input component 210, output component 212, and communication interface 214.

Bus 202 includes a component that permits communication among the components of device 200. In some non-limiting embodiments or aspects, processor 204 is implemented in hardware, firmware, or a combination of hardware and software. For example, processor 204 includes a processor (e.g., a central processing unit (CPU), a graphics processing unit (GPU), an accelerated processing unit (APU), etc.), a microprocessor, a digital signal processor (DSP), and/or any processing component (e.g., a field-programmable gate array (FPGA), an application-specific integrated circuit (ASIC), etc.) that can be programmed to perform a function. Memory 206 includes a random access memory (RAM), a read only memory (ROM), and/or another type of dynamic or static storage device (e.g., flash memory, magnetic memory, optical memory, etc.) that stores information and/or instructions for use by processor 204.

Storage component 208 stores information and/or software related to the operation and use of device 200. For example, storage component 208 includes a hard disk (e.g., a magnetic disk, an optical disk, a magneto-optic disk, a solid state disk, etc.), a compact disc (CD), a digital versatile disc (DVD), a floppy disk, a cartridge, a magnetic tape, and/or another type of computer-readable medium, along with a corresponding drive.

Input component 210 includes a component that permits device 200 to receive information, such as via user input (e.g., a touch screen display, a keyboard, a keypad, a mouse, a button, a switch, a microphone, etc.). Additionally, or alternatively, input component 210 includes a sensor for sensing information (e.g., a global positioning system (GPS) component, an accelerometer, a gyroscope, an actuator, etc.). Output component 212 includes a component that provides output information from device 200 (e.g., a display, a speaker, one or more light-emitting diodes (LEDs), etc.).

Communication interface 214 includes a transceiver-like component (e.g., a transceiver, a separate receiver and transmitter, etc.) that enables device 200 to communicate with other devices, such as via a wired connection, a wireless connection, or a combination of wired and wireless connections. Communication interface 214 can permit device 200 to receive information from another device and/or provide information to another device. For example, communication interface 214 includes an Ethernet interface, an optical interface, a coaxial interface, an infrared interface, a radio frequency (RF) interface, a universal serial bus (USB) interface, a Wi-Fi interface, a cellular network interface, and/or the like.

Device 200 can perform one or more processes described herein. Device 200 can perform these processes based on processor 204 executing software instructions stored by a computer-readable medium, such as memory 206 and/or storage component 208. A computer-readable medium (e.g., a non-transitory computer-readable medium) is defined herein as a non-transitory memory device. A memory device includes memory space located inside of a single physical storage device or memory space spread across multiple physical storage devices.

Software instructions can be read into memory 206 and/or storage component 208 from another computer-readable medium or from another device via communication interface 214. When executed, software instructions stored in memory 206 and/or storage component 208 cause processor 204 to perform one or more processes described herein. Additionally, or alternatively, hardwired circuitry can be used in place of or in combination with software instructions to perform one or more processes described herein. Thus, embodiments described herein are not limited to any specific combination of hardware circuitry and software.

Memory 206 and/or storage component 208 may include data storage or one or more data structures (e.g., a database, etc.). Device 200 may be capable of receiving information from, storing information in, communicating information to, or searching information stored in the data storage or one or more data structures in memory 206 and/or storage component 208. In some non-limiting embodiments or aspects, the information may include data (e.g., crypto order data, one or more prior crypto orders, one or more order books, etc.) associated with one or more crypto order exchanges.

The number and arrangement of components shown in FIG. 2 are provided as an example. In some non-limiting embodiments or aspects, device 200 includes additional components, fewer components, different components, or differently arranged components than those shown in FIG. 2. Additionally, or alternatively, a set of components (e.g., one or more components) of device 200 can perform one or more functions described as being performed by another set of components of device 200.

Referring now to FIG. 3, FIG. 3 is a flowchart of a non-limiting embodiment or aspect of a process 300 for a crypt order synchronized exchange system. In some non-limiting embodiments or aspects, one or more of the steps of process 300 are performed (e.g., completely, partially, etc.) by crypto safety device 102 (e.g., safety application, etc.), safety system 104, global exchange 106, local crypto exchange 108 and communication network 110. In some non-limiting embodiments or aspects, one or more of the steps of process 300 are performed (e.g., completely, partially, etc.) by another device or a group of devices separate from or including crypto safety device 102, safety system 104, global exchange 106, local crypto exchange 108, and/or communication network 110.

As shown in FIG. 3, at step 302, process 300 includes receiving a crypt order in a global exchange 106 via a first private network of a crypto safety system. In some non-limiting embodiments or aspects, safety system 104 receives a crypt order in a global exchange 106 via a first private network of the safety system 104. For example, safety system 104 receives a crypt order that was generated by crypto safety device 102.

Global exchange 106 receives, inspects, and sends a crypt order as further shown and explained with respect to FIG. 1. For example, global exchange 106 (e.g., a management server, one or more management servers, one or more management computing devices, etc.) may inspect a crypt order received from safety device 102 (e.g., a safety computing device, a safety application of a computing device, etc.). While inspecting a crypt order, global exchange 106 may determine a crypt order includes global crypto criteria and/or local crypto criteria, or in other embodiments, may inspect a crypt order may include a tokenized value created at the safety device 102 and embedded or attached to the crypt order. The global exchange 106 may direct the crypt order (e.g., one or more crypt orders, one or more portions of a crypto order, such as crypto information or crypto criteria, etc.), to an exchange server (e.g., a local crypto exchange, one or more exchange servers, a local computing device, etc.).

In some non-limiting embodiments or aspects, crypto safety device 102, after generating a crypt order, communicates the crypt order via a private network to prevent unauthorized access to crypt order information and local crypto exchange 108. For example, crypto safety device 102, after generating a crypt order, communicates the crypt order by transmitting the completed crypt order over a private network by using a unique communication, such as a crypt order message that is unique to safety system 104. In other non-limiting embodiments or aspects, safety system 104 provides network interfaces that can be used to configure a private network. A private network may be predetermined for points on the network, such as, for example a predetermined network interface for communicating between safety device 102 (e.g., one or more computing devices, software applications, etc.) and the global exchange 106.

In some non-limiting embodiments or aspects, the global exchange 106 generates one or more private networks for connecting a global domain of the global exchange 106 with one or more local domains of one or more respective local crypto exchanges. For example, a global domain may include one or more connected computing devices, such as one or more computing devices of the global exchange 106, or additionally may include one or more software applications executing on the global exchange 106. In some non-limiting embodiments or aspects, a local domain may include one or more computing devices connected to the local crypto exchange 108 (e.g., one or more computing devices of local crypto exchange 108, etc.), or additionally may include one or more software applications executing on the local crypto exchange 108.

In some non-limiting embodiments or aspects, safety system 104 updates global trade information or local trade information related to a crypt order as crypt order criteria are completed. For example, safety system 104 sends updates (e.g., news, messages, etc.) relating to global trades or local trades to one or more crypto safety devices 102. In response to determining a private crypt order exists based on the one or more private crypto criteria (e.g., secret information, private crypto information, requirement for approval, etc.), safety system 104 determines a communication address of one or more local crypto exchange servers based on the crypt order information. For example, safety system 104 determines a communication address for a target computing device, such as a global exchange 106 or local crypto exchange 108, for monitoring. Safety system 104 may monitor or generate a communication address for the target in global exchange 106 or local crypto exchange 108 for serving local crypto orders.

In some non-limiting embodiments or aspects, global exchange 106 or local crypto exchange 108 generates a crypt order or safety token for protecting communication with global exchange 106 or local crypto exchange 108. Global exchange 106 or local crypto exchange 108 then generates the crypt order or safety token and provides one or more orders to a queuing computing device for an approval which is determined based on the crypt order being satisfied in global exchange 106 or local crypto exchange 108 (e.g., the crypt order criteria is met, a response is generated, a crypt order is completed, etc.).

In some non-limiting embodiments or aspects, it is envisioned that many traders (e.g., users, customers, clients, etc.) may be registered to use the safety system 104, and that each client may possess one or more private keys (e.g., password, etc.) and one or more public keys (e.g., point of access to a wallet, an address, an address identifier, etc.) in their wallet associated with different crypto currencies or blockchains. Therefore, it is desirable to provide unique tokens for each of the traders or, in other embodiments, each of the local crypto exchanges 108 to protect communications with traders, more efficiently track and manage a variety of keys, and provide a mechanism to store all keys in a single universal key. This uniqueness may be provided, at least in part, through the use of a safety token. In particular, the safety token may include a trader tag (e.g., a trader code or trader key) to use in the token creation process. The trader tag may be combined, incorporated, XORed, or used as an input to an encryption or hashing function for each private key or public key, or in other embodiments as a universal crypto key by irreversibly hashing a plurality of keys and providing the universal key as a protection mechanism. Alternatively, the trader tag may be used as the initial input (e.g., initial key) for a hash crypt key has operation, and subsequent crypt key hash operations may use the previous hash result.

Through the use of trader-specific tags, data records processed for one trader will not be reproducible unless the same tokens and trader tag are used. In some non-limiting embodiments or aspects, the trader name (e.g., identifying information, etc.) is stored in a data file in at least one of the global exchange 106 or local crypto exchange 108, and, based on the trader name, the trader tag is generated or created. In this way, the actual value being used as the trader tag will not be discernable to parties other than those of the safety system 104. However, it will be appreciated that the trader name itself may be used as a key and that, in other embodiments, the trader tag may be known by the safety device 102. In some non-limiting embodiments or aspects, a crypt order from a trader may also be routed to a specific local crypto exchange based on a trader tag. The trader tag may be created by a local crypto exchange to also uniquely identify a local crypto exchange 108 (e.g., a unique computing device of a local crypto exchange) to ensure that a user may return to a same computing device for any subsequent transactions. The global exchange 106 may be securely updated to route based on the unique token. Other arrangements and configurations are possible.

As shown in FIG. 3, at step 304, process 300 includes determining a local crypt order based on the crypt order including one or more private crypto criteria. In some non-limiting embodiments or aspects, global exchange 106 determines, based on crypt order information, if a local crypt order includes one or more private crypto criteria to be completed as a private crypt order, wherein the crypt order information, or a safety token based on the crypt order information, is transformed to identify at least one local crypto exchange 108. For example, global exchange 106 determines a local crypt order based on the crypt order including one or more private crypto criteria, and in some non-limiting embodiments or aspects, a local crypto exchange 108 is protected from external threats to provide security during processing of the private crypto criteria. The global exchange 106 may inspect the crypto order to determine private crypto criteria. For example, a cryptocurrency node may be required if the crypt order includes a cryptocurrency order, such as a buy order or a sell order.

In some non-limiting embodiments or aspects, safety system 104 receives or provides local crypto information, or in some non-limiting embodiments or aspects, a local crypto token including one or more fields of crypto information (e.g., tokenized fields, etc.) from the crypt order information. In some non-limiting embodiments or aspects, safety system 104 receives or provides private crypto information (e.g., crypto criteria, a node, a token, etc.) for determining a crypto order domain associated with a private network.

In some non-limiting embodiments or aspects, one of safety device 102, global exchange 106, or local crypto exchange 108 sends a synchronized crypt order or the safety token comprising crypt order information (e.g., information associated with a crypto criteria, information associated with a related crypt order, etc.). For example, global exchange 106 generates, or in other non-limiting embodiments or aspects, transforms the safety token based on crypt order information to identify at least one of a local crypto exchange 108 or an originating crypto safety device 102. In some non-limiting embodiments or aspects, crypt order information may be associated with or include information for a private key of the crypt order or a private key of one or more accounts (e.g., user cryptocurrency accounts, accounts for a crypto node, etc.). The crypt order information may be used by global exchanges 106 to confirm or identify a local crypto exchange 108, node, or crypt order, and in other non-limiting embodiments or aspects, may confirm or identify a local crypto exchange 108, node, or crypt order based on a safety token.

As shown in FIG. 3, at step 306, process 300 includes generating a second private network for communicating a local crypt order and monitoring for a global crypt order. As an example, global exchange 106 generates a second private network for communicating a local crypt order and monitors for a global crypt order.

In some non-limiting embodiments or aspects, global exchange 106 generates one or more private networks for connecting a global domain of the global exchange 106 with one or more local domains of one or more respective local exchanges 108.

In some non-limiting embodiments or aspects, a local crypto exchange 108 may determine global criteria for processing. For example, a local crypto exchange 108 (or a second global exchange 106) may determine a global criteria that may not be processed locally. In such an example, a local crypto exchange 108 may continuously or periodically monitor one or more unique crypt order interfaces that provide access to global exchange 106, or in other non-limiting embodiments or aspects, provide access to a network for global exchanges for processing global criteria. Local crypto exchange 108 may determine a unique interface from the one or more unique crypt order interfaces for communicating with the global exchange 106. In some non-limiting embodiments or aspects, while monitoring the crypt order interface, local crypto exchange 108 may block crypt order or other messages. For example, local crypto exchange 108 may block at least one crypt order from acquiring the first or second private network to prevent an external request from having network access.

As shown in FIG. 3, at step 308, process 300 includes completing an exchange of the local crypt order by satisfying the one or more private crypto criteria in the local crypto exchange 108. As an example, local crypto exchange 108 completes an exchange of the local crypt order by satisfying the one or more private crypto criteria in local crypto exchange 108, and the local crypt order is approved in local crypto exchange 108 based on the crypt order information via a second private network.

In some non-limiting embodiments or aspects, local crypto exchange 108 completes an exchange of a local crypt order while protecting the local crypt order. For example, local crypto exchange 108 confirms crypt order information for an authorized device, including one or more of a crypto safety device 102, one or more global exchanges 106, or one or more local crypto exchanges 108. In some non-limiting embodiments or aspects, local crypto exchange 108 additionally blocks a crypt order, an unconfirmed or unauthorized message (e.g., received from an unknown computing device, software application, unauthorized user, etc.), or one or more messages associated with completing a crypt order sent from an external device that may not be confirmed.

In some non-limiting embodiments or aspects, crypt order information includes crypt order node information identifying at least one node of a blockchain network. In some examples, the at least one node is associated with at least one one of a plurality of distributed cryptocurrency nodes, a privately held node, a government node, or a limitedly distributed node for maintaining a transaction record for a crypt order or a private criteria of a crypt order.

In some non-limiting embodiments or aspects, crypto safety device 102 (e.g., one or more computing devices of crypto safety device 102, etc.) initiate a crypt order by selecting global exchange 106 in a user interface, wherein global exchange 106 is associated with a preferred local crypto exchange 108. In some non-limiting embodiments or aspects, safety device 102 may determine the preferred local crypto exchange 108 or may direct a communication to global exchange 106 that includes one or more measured characteristics associated with a metric about a security of the preferred local crypto exchange 108.

In some non-limiting embodiments or aspects, safety device 102 generates or sends a crypt order to the global exchange 106. In some non-limiting embodiments or aspects, when approving the local crypt order in local crypto exchange 108 (e.g., one or more computing devices, one or more local crypto exchanges 108, etc.) the local crypt order identifies a cryptocurrency node (e.g., includes identifying information in the crypt order, an identifier, a tokenized identifier, crypto criteria, etc.) to update while protecting one or more local crypt order exchanges from external computing devices. For example, safety device 102 sends a crypt order that requires a cryptocurrency node and a portion of information for the one or more private crypto criteria, one or more crypt orders, or one or more private keys, identifies the local crypto exchange 108 that includes a node associated with the crypt order for approval of the order.

Referring now to FIGS. 4A-4C, FIG. 4A is a diagram of a non-limiting embodiment of a crypt order synchronized messaging environment 400 in which systems and/or methods, described herein, may be implemented for initiating a secure crypt order. FIG. 4B is a diagram of a non-limiting embodiment or aspect of order manager 412 of crypt order synchronized messaging environment 400. FIG. 4C is a diagram of a non-limiting embodiment or aspect of order servicer 414 of crypt order synchronized messaging environment 400.

As shown in FIG. 4A, systems and/or devices of crypt order synchronized messaging environment 400 include safety application 402, management server 406, and/or exchange server 408 in an arrangement to interconnect via wired connections, wireless connections, or a combination of wired and wireless connections. Additionally, or alternatively, network devices (e.g., one or more firewalls, routers, load balancers, gateways, etc.) can be arranged within and/or between interconnections of systems, servers, applications, or devices of crypt order synchronized messaging environment 400 to facilitate a safety arrangement. In some non-limiting embodiments or aspects, safety application 402 can be the same or similar to crypto safety device 102, management server 406 can be the same or similar to global exchange 106, exchange server 408 can be the same or similar to local crypto exchange 108, and safety system 104 can include one or more safety applications 402 (e.g., one or more devices operating a safety application 402, etc.), management servers 406 (e.g., one or more devices operating management servers 406, etc.), and/or exchange servers 408 (e.g., one or more devices operating exchange servers 408, etc.).

As shown in FIG. 4A, in some non-limiting embodiments or aspects, management server 406 includes order manager 412 and order servicer 414. In other non-limiting embodiments or aspects, exchange server 408 includes order manager 412, order servicer 414, and trade manager 416. In some non-limiting embodiments or aspects, management server 406 and exchange server 408 include separate modules for order manager 412 and order servicer 414. In this way, crypt order synchronized messaging environment 400 is programmed or configured to determine a local portion of a crypt order in a local crypto exchange of exchange server 408, the local portion including private crypto criteria based on private crypto information, and management server 406 is programmed or configured to determine a global portion of a crypt order in a global exchange of management server 406, the global portion including non-private crypto criteria associated with the crypt order update request (e.g., news stories, price updates, currently pending orders, etc.).

In some non-limiting embodiments or aspects, management server 406 includes software components for an order manager 412 and an order servicer 414 to track crypt orders, and exchange server 408 includes software components for an order manager 412 and an order servicer 414 to track crypt orders. For example, crypto safety system 104 provides an order manager 412 of an exchange server 408 in a separate component, and different from an order manager 412 of management server 406 and additionally, provides an order servicer 414 that is separate and different from the order servicer of the management server 406.

For example, an order manager 412 of an exchange server 408 provides a crypto order inventory that is protected, private, and securely managed or monitored to determine a supply of orders. In this way, the order manager 412 may eliminate redundancy and delays in crypt order submissions, monitor processing of crypt orders (e.g., for data entry mistakes, transmission errors, order entry problems that may lead to fulfillment mistakes, etc.), fulfill crypt orders by synchronizing an order book with a crypto node, track complications from outdated or inaccurate crypto information or cryptocurrency node information, and other problems with cryptocurrency nodes without exposing private or protected crypto information to the management server 406.

In some non-limiting embodiments or aspects, the order manager 412 of the management server 406 may provide, service, or inspect an order before transferring control of the order to an exchange server 408.

With continued reference to FIG. 4A, in some non-limiting embodiments or aspects, at A-1, safety application 402 creates or constructs a crypt order and sends it to management server 406. For example, safety application 402 creates, constructs, and/or sends a crypt order to buy or sell an amount of cryptocurrency at a market price or in other non-limiting embodiments or aspects, safety application 402 creates, constructs, and/or sends a crypt order to buy or sell an amount of cryptocurrency at a limit price, the transaction details for market price and limit price further shown in FIGS. 8A-8E and 9A-9H.

In some non-limiting embodiments or aspects, at D-1, management server 406 determines if the crypt order is valid (e.g., includes a bid, ask, amount, price, etc.). This information is displayed on two sides of the order book known as the buy-side and sell-side. For example, if management server 406 determines the crypt order is not valid, at A-2 management server 406 sends a response to the order request from safety application 402 with notification of an error associated with the order. In another example, if management server 406 determines the crypt order is valid, management server 406 then determines, at D-2, if an order is a management server crypt order. If management server 406 determines the crypt order is not a management server crypt order (e.g., a crypt order that can be handled on a server, a crypt order having protected information, etc.), at A-3, management server 406 creates or constructs a crypt order (e.g., a crypt order message, etc.) and forwards the crypt order to exchange server 408, to be stored at A-4 as an entry in a crypt order queue (e.g., in memory, in a database, etc.). For example, if a crypt order includes a buy or sell request for a cryptocurrency requiring communication with a secure cryptocurrency node, management server 406 forwards the crypt order to the exchange server 408.

Alternatively, if management server 406 determines the crypt order is a management server crypt order (e.g., a crypt order that can be handled on an unprotected server, a crypt order without private information, etc.), at A-5, management server 406 creates or constructs a crypt order (e.g., a crypt order message, etc.), and then stores the crypt order at A-6 as an entry in a crypt order queue (e.g., in memory, in a database, etc.), or in other non-limiting embodiments or aspects, stores the crypt order in one or more devices of management server 406 (e.g., a global exchange, etc.) or in one or more devices of exchange server 408 (e.g., a local crypto exchange, etc.).

In some non-limiting embodiments or aspects, at D-13, management server 406 determines if additional action is required, and if not, a response with success is communicated at A-17. At A-15, management server 406, determines further actions for further processing before a response is communicated to a safety application 402 at A-17, with success, or in other examples, at A-16 communicating an error.

Referring now to FIG. 4B, FIG. 4B, in some non-limiting embodiments or aspects, at A-7 order manager 412 checks the queue (e.g., order book, etc.) or an order ledger for orders. In some examples, at D-3, if management server 406 determines orders are present, an order is selected for a transaction. In such an example, order manager 412 analyzes the order, and determines, for example, at D-4 if the order timed out, or at D-5, further determines if an order has satisfied a threshold number of attempts (e.g., max number of attempts, etc.).

In some non-limiting embodiments or aspects, if D-4 or D-5 are found to be true, then at A-8, order manager 412 responds with an error message and/or at A-9 order manager 412 removes the order (e.g., the selected order, etc.) and returns to A-7 to check the queue for additional orders. In some non-limiting embodiments or aspects, order manager 412 may continue to check the queue repeatedly for orders until an order is found in the queue.

In some non-limiting embodiments or aspects, at D-12, order manager 412 determines if the order can be completed, and if so, at A-17, responds with a success message. If the order is determined unable to be completed, at A-14, order manager 412 removes the order (e.g., the completed order, etc.), and returns control to A-7 to check the queue for orders (e.g., continually check for orders, etc.).

Referring now to FIG. 4C, in some non-limiting embodiments or aspects, order manager 412 transitions control to order servicer 414, for determining, at D-6, if criteria associated with the order can be completed. In some non-limiting embodiments or aspects, order servicer 414, at A-13, attempts to complete the criteria, such as, for example, at D-7, by making a node call, at D-8, by making a website call, or at D-9, by making a local call depending on the crypto criteria of the message. Any other criteria can be added to the order servicer 414, such as at step D-9, when the order servicer 414 determines a local call or some other criteria is being used (e.g., verification of a signature, verification of a private signing key, determining a public key for a transaction, etc.).

In some non-limiting embodiments or aspects, at D-10, order servicer 414 determines if a call can be completed on this server. At D-11, order servicer 414 determines a criteria requires one or more calls to an external server (e.g., a different server, device, system, etc.), and in other embodiments, determines only that a call cannot be completed. In such an example, at A-11 order servicer 414 creates or constructs a crypt order (e.g., a message, a crypt order message, a message associated with a crypt order) and communicates the crypt order to management server 406 or exchange server 408. In some non-limiting embodiments or aspects, at D-10, order servicer 414 determines the call can be completed on the current server (e.g., the management server 406 or exchange server 408, one or more devices of the management server 406 or exchange server 408, one or more services of the management server 406 or exchange server 408, etc.), and at A-12, order servicer 414 completes the call.

Referring now to FIG. 5, FIG. 5 is a diagram of a non-limiting embodiment of a synchronized connecting process of crypt order synchronized messaging environment 500 on which systems and/or methods, described herein, can be implemented. As shown in FIG. 5, in some non-limiting embodiments, crypt orders or crypt order updates are processed between crypto safety device 402 and management server 406 after a synchronized connecting process. For example, in some non-limiting embodiments or aspects, a synchronized connecting process of crypt order synchronized messaging environment 500 includes confirming or authorizing crypto safety application 402 in management server 406, while exchange server 408 (not shown in FIG. 5) remains securely protected from communications involving external communications from a crypto safety application 402 or other external communications from other devices. In some non-limiting embodiments or aspects, safety application 402 can be the same or similar to crypto safety device 102, management server 406 can be the same or similar to global exchange 106, exchange server 408 can be the same or different can be the same or similar to local crypto exchange 108, and safety system 104 can include one or more safety applications 402 (e.g., one or more devices operating a safety application 402, etc.), management servers 406 (e.g., one or more devices operating an management server 406, etc.), local crypto exchanges 408 (e.g., one or more devices operating a local crypto exchange 408, etc.). Systems and/or devices of environment 500 can interconnect via wired connections, wireless connections, or a combination of wired and wireless connections. Additionally, or alternatively, network devices (e.g., one or more firewalls, routers, load balancers, gateways, etc.) can be arranged within and/or between interconnections of systems, servers, applications, or devices of the crypt order synchronized messaging environment 500 to facilitate a safety arrangement.

In some non-limiting embodiments or aspects, safety application 402 at A3-1 calls to establish an encrypted socket connection. For example, safety application 402 communicates via a private connection and determines at D3-1 if it is banned (e.g., a blocked address, on a black list, etc.). Management server 406 may determine it is not banned, and at A3-2 communicate a response (e.g., respond, transmit a signal initiating a connection, etc.) having a public key. Alternatively, a banned safety application 402, at A3-3 disconnects and logs an IP address of device. For example, if a safety application 402 (e.g., a safety device, etc.) or one or more applications of a safety device, such as types of software known to provide security attacks, are banned, a connection is ended.

With continuing references to FIG. 5, in some non-limiting embodiments or aspects, safety application 402 at A3-4 encrypts a client public key with a server public key. In some non-limiting embodiments or aspects, management server 406 at A3-5 decrypts a public key. In some non-limiting embodiments or aspects, management server 406 at A3-6 encrypts client and server certificates with client public key and responds to client.

In some non-limiting embodiments or aspects, safety application 402 at A3-7 decrypt certificates, a communication establishes an encrypted socket connection. In some non-limiting embodiments or aspects, management server 406 at D3-2 determine if secure connection established, and at D3-3 update management server communicates a crypt order in crypt order synchronized messaging environment 500. Alternatively, at D3-4 determines if reconnect criteria met or at A3-8 disconnects and logs an IP address.

Referring now to FIGS. 6A and 6B, FIGS. 6A and 6B show a diagram of a non-limiting embodiment of a trade manager software component of a crypt order synchronized messaging environment 600 to manage a trade of a secure crypt order in which systems and/or methods, described herein, can be implemented. As shown in FIGS. 6A and 6B, in some non-limiting embodiments, exchange server 408 manages trade orders for cryptocurrencies while remaining securely protected from insecure or other communications involving external communications from the crypto safety application 402 or other external communications from other devices. In some non-limiting embodiments or aspects, safety application 402 can be the same or similar to crypto safety device 102, management server 406 can be the same or similar to global exchange 106, exchange server 408 can be the same or different can be the same or similar to local crypto exchange 108, and safety system 104 can include one or more safety applications 402 (e.g., one or more devices operating a safety application 402, etc.), management servers 406 (e.g., one or more devices operating an management server 406, etc.), local crypto exchanges 108 (e.g., one or more devices operating a local crypto exchange 108, etc.). Systems and/or devices of environment 600 can interconnect via wired connections, wireless connections, or a combination of wired and wireless connections. Additionally, or alternatively, network devices (e.g., one or more firewalls, routers, load balancers, gateways, etc.) can be arranged within and/or between interconnections of systems, servers, applications, or devices of the crypt order synchronized messaging environment 600 to facilitate a safety arrangement.

In some non-limiting embodiments or aspects, trade manager service 416 of exchange server 408, at A4-1 retrieves order books for all symbols (e.g., all node networks, all symbols of orders in queue, etc.). Trade manager service 416 of exchange server 408, at A4-2 updates an order book (e.g., an order book for a crypt order, etc.). For example, an order book update may include order details, such as buy, ask, sell at market, sell at limit, keys, public keys, and account information. Trade manager service 416 of exchange server 408, at D4-1, determines a market order, or in other embodiments at D4-2, determines a limit order.

In some non-limiting embodiments or aspects, trade manager service 416 of exchange server 408, at D4-3, determines an order match. After matching an order, trade manager service 416 of exchange server 408, at A4-3 updates pending limit orders. For example, management server 416 updates any limit orders that do not match an order book entry.

With continuing reference to FIGS. 6A and 6B, in some non-limiting embodiments or aspects, trade manager service 416 of exchange server 408, at D4-4 determines if expired limit orders exist. In some non-limiting embodiments or aspects, trade manager service 416 of exchange server 408, at A4-4, removes expired limit orders and/or remaining, and, at A4-5 fills the crypt order. For example, trade manger service initiates and sends a message as shown in FIGS. 8 and 9 hereafter. In an example, a safety device 204 provides a display portion for displaying screens of the non-limiting embodiments shown in the screens. Trade manager service 416 of exchange server 408, at A4-6 removes one or more orders from an order book.

In some non-limiting embodiments or aspects, trade manager service 416 of exchange server 408, at D4-5, determines an order is matched with both a taker and a giver of a cryptocurrency, otherwise, at A4-7 issues a cancel order. In some non-limiting embodiments or aspects, trade manager service 416 of exchange server 408, at A4-8, updates a trade order with fill order details, and checks for order details and other problems in the order, order book, or transaction details at D4-6.

In some non-limiting embodiments or aspects, trade manager service 416 of exchange server 408, at A4-9, creates or constructs a pending transaction and continues with pending orders if successful at D4-8. For example, exchange server 405 determines pending orders by determining details associated with a pending order (e.g., a crypt order having one or more fields with details, a crypt order object having one or more fields with details of the pending orders, etc.).

With continuing reference to FIGS. 6A and 6B, in some non-limiting embodiments or aspects, trade manager service 416 of exchange server 408, at A4-10, verifies one or more balances. In some non-limiting embodiments or aspects, trade manager service 416 of exchange server 408, at A4-11, creates or constructs and queue crypt order. In some non-limiting embodiments or aspects, trade manager service 416 of exchange server 408, at A4-12, creates raw transactions. In some non-limiting embodiments or aspects, trade manager service 416 of exchange server 408, at A4-13, updates pending transaction and continues if successful at D4-7.

Referring now to FIGS. 7A, 7B and 7C, FIGS. 7A-7C show a diagram of a non-limiting embodiment or aspect for synchronizing a local crypto exchange server and a global exchange server in a crypt order synchronized messaging environment 700. As shown in FIGS. 7A-7C, systems and/or devices of environment 400 include safety application 402, management server 406, and/or exchange server 408, and crypto safety system 420, in an arrangement to interconnect via wired connections, wireless connections, or a combination of wired and wireless connections. Additionally, or alternatively, network devices (e.g., one or more firewalls, routers, load balancers, gateways, etc.) can be arranged within and/or between interconnections of systems, servers, applications, or devices of the crypt order synchronized messaging environment 700 to facilitate a safety arrangement. In some non-limiting embodiments or aspects, safety application 402 can be the same or similar to crypto safety device 102, management server 406 can be the same or similar to global exchange 106, exchange server 408 can be the same or different can be the same or similar to local crypto exchange 108, and safety system 104 can include one or more safety applications 402 (e.g., one or more devices operating a safety application 402, etc.), management servers 406 (e.g., one or more devices operating an management server 408, etc.), local crypto exchanges 408 (e.g., one or more devices operating a local crypto exchange 408, etc.).

As shown in FIGS. 7A-7C, in some non-limiting embodiments or aspects, management server 406 and exchange server 408 are programmed or configured to operate in crypt order synchronized messaging environment 700 to approve a trade order. In this way, for example, the safety crypt order synchronized messaging environment 700 is programmed or configured to more efficiently and in a protected manner, determine an approved trade order having a local portion of a crypt order in a local crypto exchange of exchange server 408 based on private crypto information and a global portion including non-private crypto criteria associated with the crypt order update request (e.g., news stories, price updates, currently pending orders, etc.). For example, Safety application 402, at A5-1 member selects approve trade and safety application 402, at A5-2 creates or constructs a crypt order approve trade order and sends it to management server 406. Management server 406, at D5-1, validates crypt order and, at A5-3, responds with error to notify a user or device of a problem with processing a crypt order.

In some non-limiting embodiments or aspects, safety application 402, or in other embodiments, crypt order management 512 of Safety application 402, at A5-4, communicates with management server to monitor the status of a crypt order or other processes.

In some non-limiting embodiments or aspects, management server 406, at D5-2, determining to generate a management server crypt order. Next, management server 406 at A5-5 creates or constructs crypt order, exchange server 408, at A5-6, queues the crypt order and at A5-7, attempts to complete criteria for approve trade order.

In some non-limiting embodiments or aspects, exchange server 408, at D5-3, obtains and determines if a trade order is successfully retrieved, at D5-4 obtains wallets by symbol (e.g., cryptocurrency or crypto symbol or type) successful, at D5-5 obtains a list of unspent coins by symbol, at D5-6 decrypt a key according to its crypto symbol, at D5-7 approves a trade order, at D5-8 confirms and updates a trade order. As an example, if any of D5-3, D5-4, D5-5, D5-6, D5-7, and/or D5-8 are unsuccessful, exchange server 408 is further programmed or configured to send responses with notification of the error, and in other embodiments, continues by selecting a different crypt order to process.

Exchange server 408 at A5-9 generates a raw transaction before approving a pending trade order (e.g., a transaction, etc.). By generating a raw transaction first, exchange server 408 can more efficiently generate or prepare a transaction during approval of a transaction. For example, exchange server 408 at A5-10, signs a transaction, such as a predefined transaction. As previously discussed, at D5-7 if the approved trade order is successful, at A5-11, a member's portion of the pending transaction is confirmed, and if at D5-8 trade order is successfully updated based on being confirmed, at A5-13, exchange server 408 may verify confirmed orders.

In some non-limiting embodiments or aspects, exchange server 408 at D5-9, when all transactions of an order are confirmed, at A5-14 sends all raw transaction's (e.g., transactions needed to complete an order, one or more discrete orders of a trade, etc.), which at A5-15 are updated and recorded as a trade.

With continuing reference to FIGS. 7A-7C, in some non-limiting embodiments or aspects, exchange server 508 at A5-16 responds with success, (e.g., responds via a private network that the action was successful) to the management server 506, which at A5-18 responds with success to the safety application 402. In some examples, exchange server 408 at D5-10 may determine additional action required and at A5-17 take additional action and responds if successful to crypt order manager 420 of safety application 402.

Referring now to FIGS. 8A-8E, FIGS. 8A-8E are illustrations of a user interface corresponding to a non-limiting embodiment of a crypto safety application implementing crypt orders and trading processes as described hereinabove with respect to synchronized exchange system show in FIG. 1. Systems and/or devices of an environment for implementing some non-limiting embodiments or aspects of FIGS. 8A-8E, include safety application 402, management server 406, and/or exchange server 408, and crypto safety system 420 to facilitate a safety arrangement. In some non-limiting embodiments or aspects, safety application 402 can be the same or similar to crypto safety device 102, management server 406 can be the same or similar to global exchange 106, exchange server 408 can be the same or different can be the same or similar to local crypto exchange 108, and safety system 104 can include one or more safety applications 402 (e.g., one or more devices operating a safety application 402, etc.), management servers 406 (e.g., one or more devices operating an management server 408, etc.), local crypto exchanges 408 (e.g., one or more devices operating a local crypto exchange 408, etc.). As shown in FIGS. 6A-6E, implementation 600 may include processes for order management including an order book, pending orders, open orders, news items related to holdings, and/or the like.

Referring now to FIGS. 9A-9H, FIGS. 9A-9H are illustrations of a user interface corresponding to a non-limiting embodiment of a crypto safety application implementing crypt orders and trading processes as described hereinabove with respect to synchronized exchange system show in FIG. 1. Systems and/or devices of an environment for implementing some non-limiting embodiments or aspects of FIGS. 9A-9H, include safety application 402, management server 406, and/or exchange server 408, and crypto safety system 420 to facilitate a safety arrangement. In some non-limiting embodiments or aspects, safety application 402 can be the same or similar to crypto safety device 102, management server 406 can be the same or similar to global exchange 106, exchange server 408 can be the same or different can be the same or similar to local crypto exchange 108, and safety system 104 can include one or more safety applications 402 (e.g., one or more devices operating a safety application 402, etc.), management servers 406 (e.g., one or more devices operating an management server 408, etc.), local crypto exchanges 408 (e.g., one or more devices operating a local crypto exchange 408, etc.). As shown in FIGS. 9A-9H, implementation 700 include user interfaces for determining key details of a transaction (e.g., master key, chain code, mnemonic code, current address, etc.), shopping (e.g., purchase of shares, miner fees, exchange fees, amount, etc.), transactions (e.g., transaction identifier, date of transaction, notification (e.g., received, sent, etc.), block chain information, accounts, addresses, amount, block data, block hash, block index, block time, time received, one or more key bits, etc.), and/or the like.

It is to be understood that the invention may assume various alternative variations and step sequences, except where expressly specified to the contrary. It is also to be understood that the specific products, systems, and processes illustrated in the attached drawings, and described in the following specification, are simply exemplary embodiments of the invention. Hence, specific dimensions and other physical characteristics related to the embodiments disclosed herein are not to be considered as limiting. As used herein, the singular form of “a”, “an”, and “the” include plural referents unless the context clearly dictates otherwise.

Although the invention has been described in detail for the purpose of illustration based on what is currently considered to be the most practical and preferred embodiments, it is to be understood that such detail is solely for that purpose and that the invention is not limited to the disclosed embodiments, but on the contrary, is intended to cover modifications and equivalent arrangements that are within the spirit and scope of the description. For example, it is to be understood that the present invention contemplates that, to the extent possible, one or more features of any embodiment can be combined with one or more features of any other embodiment.

What is claimed is:

1. A computer-implemented crypt order synchronized exchange method for protecting crypt orders, comprising:
receiving a crypt order in a global exchange via a first private network of a crypto safety system;
determining, in the global exchange and based on crypt order information, a local crypt order including one or more private crypto criteria to be completed as a private crypt order, wherein the crypt order information, or a safety token based on the crypt order information, identifies at least one local crypto exchange;
generating a second private network for communicating a local crypt order or monitoring a second private network for a global crypt order; and
completing an exchange of the local crypt order by satisfying the one or more private crypto criteria in the local crypto exchange, wherein the local crypt order is approved in the local crypto exchange based on the crypt order information via a second private network.

2. The computer-implemented crypt order synchronized exchange method of claim 1, further comprising:
generating the crypt order at a crypto safety device; and
communicating the crypt order via a private network to prevent unauthorized access to crypt order information and the local crypto exchange, wherein communicating comprises transmitting the completed crypt order over a private network comprising a predefined unique communication and predetermined network interface.

3. The computer-implemented crypt order synchronized exchange method of claim 1, wherein the crypt order information includes crypt order node information identifying at least one node of a blockchain network and the at least one node is associated with a at least one of a plurality of distributed cryptocurrency nodes, a privately held node, a government node, or a limited distributed node, for maintaining a transaction record for a crypt order or a private criteria of a crypt order.

4. The computer-implemented crypt order synchronized exchange method of claim 1, wherein determining the global criteria, further comprising:
monitoring one or more unique crypt order interfaces; and
blocking at least one crypt order from obtaining the first or second private network to prevent an external requester having network access.

5. The computer-implemented crypt order synchronized exchange method of claim 1, wherein completing an exchange of the local crypt order, further comprising:
protecting the local crypt order by confirming crypt order information for an authorized one or more of: a crypto safety device, one or more global exchanges, or one or more local exchanges; and
blocking a crypt order, or one or more associated messages, from an external device that cannot be confirmed.

6. The computer-implemented crypt order synchronized exchange method of claim 5, wherein at least one of the crypto safety device, the global exchange, or the local crypto exchange sends a synchronized crypt order or the safety token comprising crypt order information associating the crypt order with a crypt order criteria or related crypt order, the safety token based on the crypt order information is transformed to identify at least one of a local crypto exchange, an originating crypto safety device, an identifier associated with a private key of the crypt order, or one or more user accounts, and wherein at least one of a plurality of global exchanges confirms a crypt order based on the safety token.

7. The computer-implemented crypt order synchronized exchange method of claim 1, further comprising:
initiating the crypt order by selecting the global exchange in a user interface, the global exchange associated with a preferred local crypto exchange server, wherein the preferred local crypto exchange server includes one or more measured characteristics associated with a metric about a security of the preferred local crypto exchange server;
sending the crypt order to the global exchange; and
approving the local crypt order in one or more local crypto exchanges, the local crypt order including a cryptocurrency node update protecting one or more local crypt order exchanges, a portion of information for the one or more private crypto criteria, one or more crypt orders, or one or more private keys, associated with approving the crypt order.

8. The computer-implemented crypt order synchronized exchange method of claim 1, wherein local crypto information or a local crypto token including one or more tokenized fields from the crypt order information provides private crypto information for determining a crypto order domain associated with a private network.

9. The computer-implemented crypt order synchronized exchange method of claim 8, wherein the global exchange generates one or more private networks for connecting a global domain of the global exchange with one or more local domains of one or more respective local exchanges.

10. The computer-implemented crypt order synchronized exchange method of claim 1, further comprising updating global trade information or local trade information related to a crypt order as crypt order criteria are completed.

11. The computer-implemented crypt order synchronized exchange method of claim 10, wherein updating global trade information or local trade information related to a crypt order, further comprising:
in response to determining the one or more private crypto criteria to be completed as a private crypt order of the crypt order require secret information, performing at least one of:
determining a target local communication address of one or more local crypto exchange servers based on the crypt order information;
monitoring the target local communication address in the local crypto exchange server for local crypto orders;
generating a crypt order or crypt order token for protecting communication between the local crypto exchange server or the global exchange; and
queuing the crypt order for approval, by determining the crypt order is satisfied in the local crypto exchange server and the global exchange.

12. A computing system for protecting crypt orders, comprising a crypto safety device, at least one global exchange, and one or more local crypto exchanges, wherein the global exchange is programmed or configured to:
a. receive a crypt order in a global exchange via a first private network from the crypto safety device;
b. determine, in the global exchange and based on crypt order information, a local crypt order including one or more private crypto criteria to be completed as a private crypt order, wherein the crypt order information, or a safety token based on the crypt order information, identifies at least one local crypto exchange;
c. complete an exchange of the crypt order by sending the local crypt order to a local crypto exchange to satisfy the one or more private crypto criteria in the local crypto exchange, wherein the local crypt order received in the local crypto exchange is based on the crypt order information via a second private network; and
d. protect a global and local crypto order including an approved order for the crypto order via the second private network to the global exchange.

13. The crypt order synchronized exchange system of claim 12, wherein the crypto safety device is further configured to:
generate the crypt order at a crypto safety device; and
communicate the crypt order via a private network to prevent unauthorized access to crypt order information and the local crypto exchange, wherein communicating comprises transmitting the completed crypt order over a private network comprising a predefined unique communication and predetermined network interface.

14. The computing system of claim 12, wherein the crypt order information includes crypt order node information identifying at least one node of a blockchain network and the at least one node is associated with a at least one of a plurality of distributed cryptocurrency nodes, a privately held node, a government node, or a limited distributed node, for maintaining a transaction record for a crypt order or a private criteria of a crypt order.

15. The computing system of claim 12, wherein the global exchange is further configured to:
monitor and generate one or more unique crypt order interfaces; and
block at least one crypt order from obtaining the first or second private network to prevent an external requester having network access.

16. The computing system of claim 12, wherein the global exchange is further configured to:
protect the local crypt order by confirming crypt order information for an authorized one or more of: a crypto safety device, one or more global exchanges, or one or more local exchanges; and
block a crypt order or one or more associated messages from an external device that cannot be confirmed.

17. The computing system of claim 12, wherein at least one of the crypto safety device, the global exchange, or the local crypto exchange sends a synchronized crypt order or the safety token comprising crypt order information associating the crypt order with a crypt order criteria or related crypt order, the token based on the crypt order information is transformed to identify at least one of a local crypto exchange, an originating crypto safety device, an identifier associated with a private key of the crypt order, or one or more user accounts, and wherein at least one of a plurality of global exchanges confirms a crypt order based on the safety token.

18. The computing system of claim 12, wherein the crypto safety device is configured to:
initiate the crypt order by selecting the global exchange in a user interface, the global exchange associated with a preferred local crypto exchange server, wherein the preferred local crypto exchange server includes one or more measured characteristics associated with a metric about a security of the preferred local crypto exchange server;
send the crypt order to the global exchange; and
approve the local crypt order in one or more local crypto exchanges, the local crypt order including a cryptocurrency node update protecting one or more private crypt order exchanges, a portion of information for the one or more private crypto criteria, one or more crypt orders, or one or more private keys, associated with approving the crypt order.

19. The computing system of claim 12, wherein local crypto information or a local crypto token including one or more tokenized fields from the crypt order information provides private crypto information for determining a crypto order domain associated with a private network.

20. A computer program product including at least one non-transitory computer-readable medium including one or more instructions that, when executed by at least one processor, cause the at least one processor to:
receive a crypt order in a global exchange via a first private network of a crypto safety system;
determine, in the global exchange and based on crypt order information, a local crypt order including one or more private crypto criteria to be completed as a private crypt order, wherein the crypt order information, or a safety token based on the crypt order information, identifies at least one local crypto exchange;
generate a second private network for communicating a local crypt order or monitoring for a global crypt order; and
complete an exchange of the local crypt order by satisfying the one or more private crypto criteria in the local crypto exchange, wherein the local crypt order is approved in the local crypto exchange based on the crypt order information via a second private network.
